(19) United States
(12) Patent Application Publication
(10) Pub. No.: US 2026/0262128 A1
(43) Pub. Date: Sep. 3, 2026

(54) METHOD AND APPARATUS FOR SETTING STAND-ALONE PRIVATE NETWORK TO UE IN RRC INACTIVE STATE IN NEXT-GENERATION MOBILE COMMUNICATION SYSTEM

(71) Applicant: Samsung Electronics Co., Ltd., Suwon-si, Gyeonggi-do (KR)

(72) Inventor: Sangyeob JUNG, Suwon-si (KR)

(21) Appl. No.: 19/164,086

(22) PCT Filed: Mar. 12, 2024
(86) PCT No.: PCT/KR2024/003165

§ 371 Date: Sep. 10, 2025

(30) Foreign Application Priority Data
Mar. 31, 2023 (KR) 10-2023-0043125

(51) Int. Cl. H04W 76/27; H04W 84/04

(52) U.S. Cl. CPC H04W 76/27; H04W 84/042

(57) ABSTRACT

The present disclosure relates to a 5G or 6G communication system for supporting a higher data transmission rate. A UE in the system is characterized by: receiving an RRC release message including a PLMN ID and NID information from a base station; and on the basis of the PLMN ID and the NID information, identifying whether or not a private network is an SNPN that can be considered equivalent to a registered SNPN.

### TECHNICAL FIELD

The disclosure relates to an operation of a user equipment (UE) and a base station in a mobile communication system. More particularly, the disclosure relates to a method of configuring a stand-alone private network to a UE in a radio resource control (RRC) inactive state in a communication system and an apparatus capable of performing the same.

### BACKGROUND ART

5-th generation (5G) mobile communication technologies define broad frequency bands such that high transmission rates and new services are possible, and may be implemented not only in “Sub 6 GHz” bands, such as 3.5 GHz, but also in “Above 6 GHz” bands referred to as mmWave including 28 GHz and 39 GHz. In addition, it has been considered to implement 6-th generation (6G) mobile communication technologies referred to as Beyond 5G systems in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra-reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting various numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information on locations and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) that is UE-satellite direct communication for providing coverage in an area in which communication with terrestrial networks is unavailable, and positioning.

In addition, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service field regarding a 5G baseline architecture (e.g., service based architecture or service based interface) for combining Network Functions Virtualization (NFV) and Software-Defined Networking (SDN) technologies, and Mobile Edge Computing (MEC) for receiving services based on UE locations.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), mixed reality (MR), and the like, 5G performance improvement and complexity reduction by utilizing artificial intelligence (AI) and machine learning (ML), AI service support, metaverse service support, and drone communication.

Also, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas, and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

A UE of a communication system to which the disclosure may apply has a plurality of communication modules. These modules transmit and receive necessary data through the respectively connected antennas. A plurality of communication systems use different frequency bands. However, using adjacent bands may cause interference between communication modules. Therefore, to mitigate the interference, there is a need to control transmission power between the communication modules.

### DISCLOSURE OF INVENTION

### Technical Problem

The disclosure is conceived to solve the above problems and aims to provide a method and apparatus for configuring a stand-alone private network to a user equipment (UE) in a radio resource control (RRC) inactive state in a wireless communication system.

Technical subjects to be achieved in an embodiment of the disclosure are not limited to the above-described technical subjects and still other technical subjects not described may be clearly understood by one of ordinary skill in the art to which the disclosure pertains from the following description.

### Solution to Problem

To solve the above problems, the disclosure provides a method performed by a user equipment (UE) in a wireless communication system, the method including receiving, from a base station, a radio resource control (RRC) release message that includes public land mobile network (PLMN) identity information (PLMN identifier (ID)) and at least one network identifier (NID) information related to the PLMN ID; shifting to RRC inactive based on the RRC release message; and identifying whether a standalone non-public network (SNPN) is an equivalent SNPN capable of being considered equivalent to a registered SNPN, based on the PLMN ID and the at least one NID information related to the PLMN ID.

To solve the above problems, the disclosure provides a method performed by a base station in a wireless communication system, the method including receiving, from a UE, a UE capability information message that includes an indicator related to a support status of an equivalent standalone non-public network (equivalent SNPN) capable of being considered equivalent to a registered SNPN; generating a radio resource control (RRC) release message that includes public land mobile network (PLMN) identity information (PLMN identifier (ID)) and at least one network identifier (NID) information related to the PLMN ID, to the UE, based on the UE capability information message; and transmitting an RRC release message that includes the PLLMN ID and the at least one NID information related to the PLMN ID.

The disclosure provides a UE in a wireless communication system, the UE including a transceiver configured to transmit and receive a signal; and a controller, and the controller is configured to receive, from a base station, a radio resource control (RRC) release message that includes public land mobile network (PLMN) identity information (PLMN identifier (ID)) and at least one network identifier (NID) information related to the PLMN ID, to shift to RRC inactive based on the RRC release message, and to identify whether a standalone non-public network (SNPN) is an equivalent SNPN capable of being considered equivalent to a registered SNPN based on the PLMN ID and the at least one NID information related to the PLMN ID.

The disclosure provides a base station in a wireless communication system, the base station including a transceiver configured to transmit and receive a signal; and a controller, and the controller is configured to receive, from a UE, a UE capability information message that includes an indicator related to a support status of an equivalent standalone non-public network (equivalent SNPN) capable of being considered equivalent to a registered SNPN, to generate a radio resource control (RRC) release message that includes public land mobile network (PLMN) identity information (PLMN identifier (ID)) and at least one network identifier (NID) information related to the PLMN ID, to the UE, based on the UE capability information message, and to transmit an RRC release message that includes the PLLMN ID and the at least one NID information related to the PLMN ID.

### Advantageous Effects of Invention

According to the disclosure, a user equipment (UE) in a radio resource control (RRC) inactive state may be configured with a stand-alone private network. More specifically, it is possible to configure a stand-alone private network to the UE in the RRC inactive state while reducing signaling overhead.

Effects that may be acquired by the disclosure are not limited to the above-described effects and still other effects not described may be clearly understood by one of ordinary skill in the art to which the disclosure pertains from the following description.

### BRIEF DESCRIPTION OF DRAWINGS

FIG. 1A illustrates a structure of a long term evolution (LTE) system for reference in describing the disclosure.

FIG. 1B illustrates a wireless protocol structure in a long term evolution (LTE) system for reference in describing the disclosure.

FIG. 1B illustrates a structure of a next-generation mobile communication system to which the disclosure applies.

FIG. 1D illustrates a wireless protocol structure of a next-generation mobile communication system to which the disclosure may apply.

FIG. 1E illustrates a procedure for a user equipment (UE) in an RRC idle state (RRC_IDLE) to access a stand-alone non-public network (SNPN) cell and to configure an RRC connection in a next-generation mobile communication system according to an embodiment of the disclosure.

FIG. 1F illustrates a procedure for a UE in an RRC inactive state (RRC_INACTIVE) to access a stand-alone non-public network (SNPN) cell and to resume an RRC connection in a next-generation mobile communication system according to an embodiment of the disclosure.

FIG. 1G illustrates a procedure for a UE in an RRC idle state (RRC_IDLE) to access a stand-alone non-public network (SNPN) cell and to configure an RRC connection in a next-generation mobile communication system according to an embodiment of the disclosure.

FIG. 1H illustrates a procedure for a UE in an RRC inactive state (RRC_INACTIVE) to access a stand-alone non-public network (SNPN) cell and to resume an RRC connection in a next-generation mobile communication system according to an embodiment of the disclosure.

FIG. 1I illustrates a procedure for a UE in an RRC inactive state (RRC_INACTIVE) to access a stand-alone non-public network (SNPN) cell and to resume an RRC connection in a next-generation mobile communication system according to an embodiment of the disclosure.

FIG. 1J illustrates a procedure for a UE in an RRC inactive state (RRC_INACTIVE) to access an SNPN cell and to resume an RRC connection in a next-generation mobile communication system according to an embodiment of the disclosure.

FIG. 1K is a block diagram illustrating an internal structure of a UE according to an embodiment of the disclosure.

FIG. 1L is a block diagram illustrating a configuration of a new radio (NR) base station according to an embodiment of the disclosure.

### MODE FOR THE INVENTION

In describing embodiments herein, descriptions related to technical contents that are well-known in the art to which the present invention pertains and are not directly associated with the present invention will be omitted. Such an omission of unnecessary descriptions is intended to prevent obscuring of the main idea of the present invention and more clearly convey the main idea.

Similarly, in the accompanying drawings, some components may be exaggerated, omitted, or schematically illustrated. Also, the size of each component does not completely reflect the actual size. In the drawings, identical or corresponding components are provided with identical reference numerals.

The advantages and features of the present invention and methods to achieve them will be apparent with reference to embodiments as described below in detail in conjunction with the accompanying drawings. However, the present invention is not limited to the embodiments set forth below, but may be implemented in various different forms. The following embodiments are provided only to completely disclose and inform those skilled in the art of the scope of the present invention, and the appended claims. Throughout the specification, the same or like reference numerals designate the same or like components.

Here, it will be understood that each block of flowchart illustrations and combinations of blocks in the flowchart illustrations may be implemented by computer program instructions. These computer program instructions may be provided to a processor of a general-purpose computer, a special purpose computer, or other programmable data processing apparatus, such that the instructions, executed via the processor of the computer or other programmable data processing apparatus, create a method for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction implies that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions executed on the computer or other programmable apparatus provide steps for implementing the functions specified in the flowchart block(s).

Also, each block may represent a module, a segment, or a portion of code, which includes one or more executable instructions for implementing the specified logical function(s). It should also be noted that in some alternative implementations, the functions noted in the blocks may occur out of order. For example, two blocks shown in succession may in fact be executed simultaneously or the blocks may sometimes be executed in the reverse order, depending on the functionality involved.

Here, the term “unit” used herein refers to a software component or a hardware component, such as a field programmable gate array (FPGA) or an application specific integrated circuit (ASIC), which performs a predetermined function. However, the term “unit” does not always have a meaning limited to software or hardware. “Unit” may be configured either to be stored in an addressable storage medium or to execute one or more processors. Therefore, “unit” includes, for example, components such as software components, object-oriented software components, class components, and task components, processes, functions, properties, procedures, sub-routines, segments of a program code, drivers, firmware, micro-codes, circuits, data, database, data structures, tables, arrays, and parameters. The components and functions provided by the “unit” may be combined into a smaller number of components and “units”, or further divided into additional components and “units”. In addition, the components and “units” may be implemented to reproduce one or more CPUs within a device or a security multimedia card. Also, the term “unit” in the embodiments may include one or more processors.

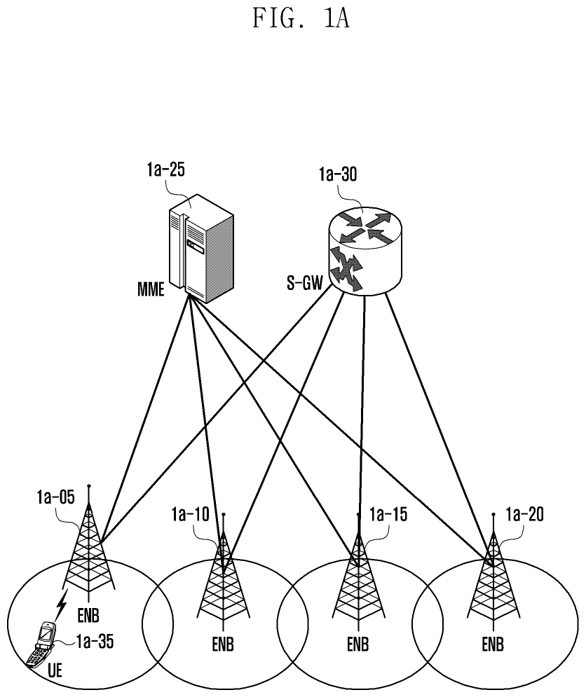

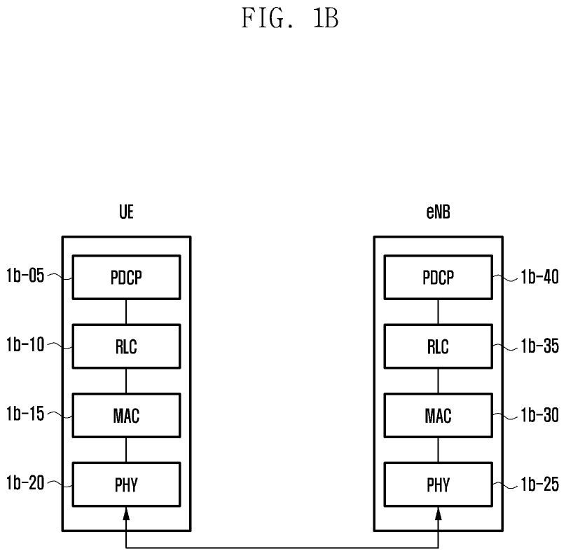

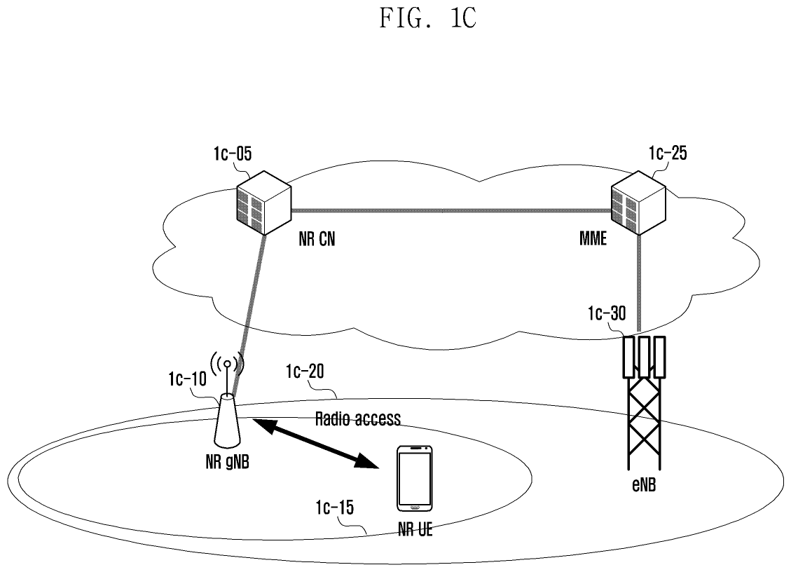

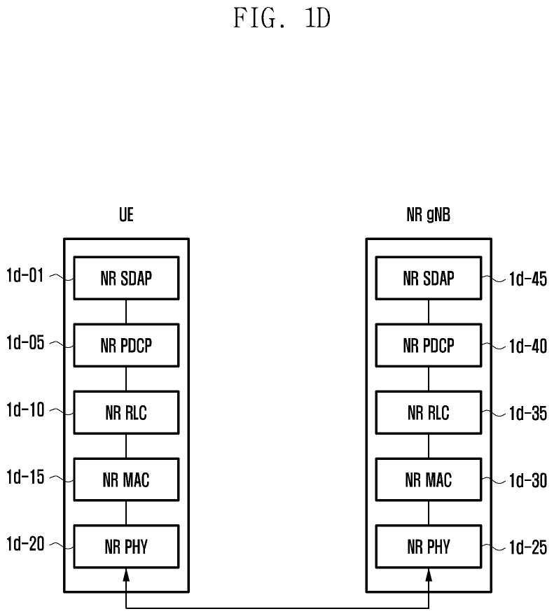

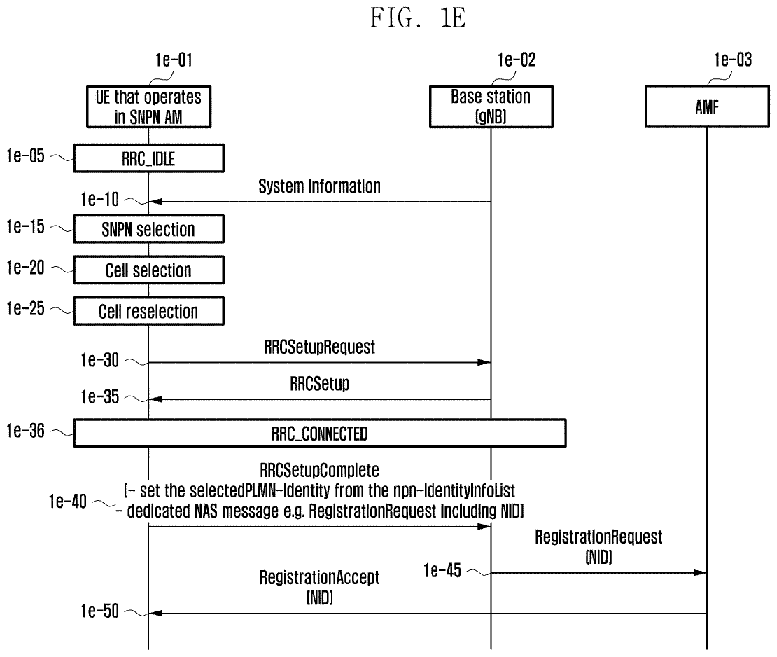

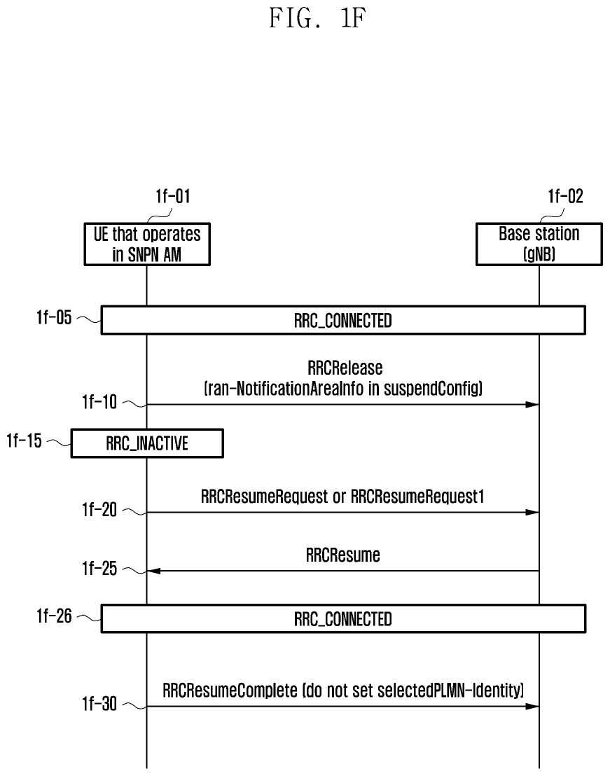

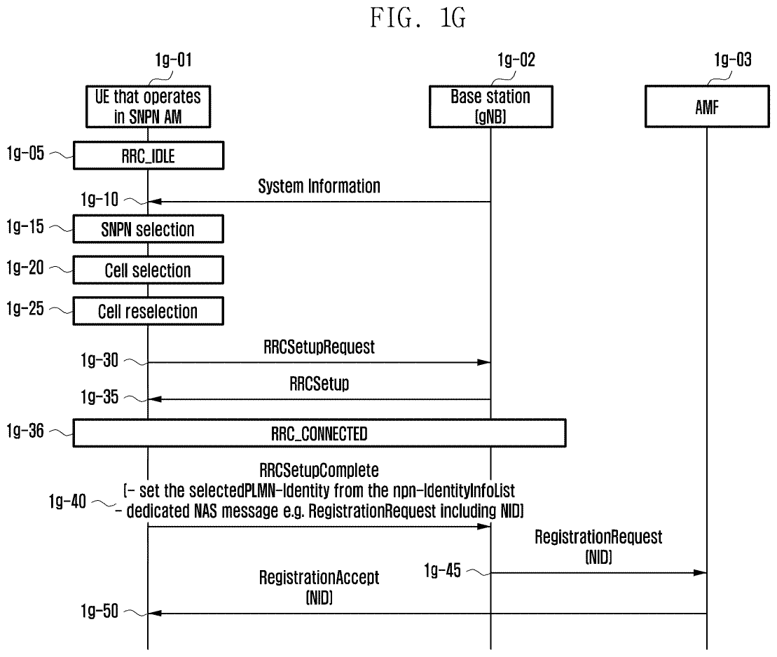

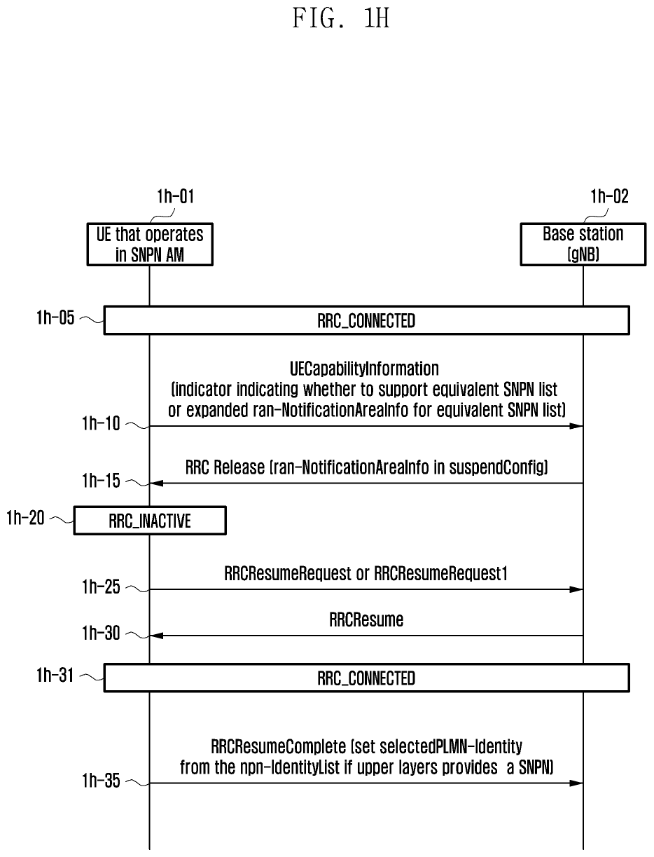

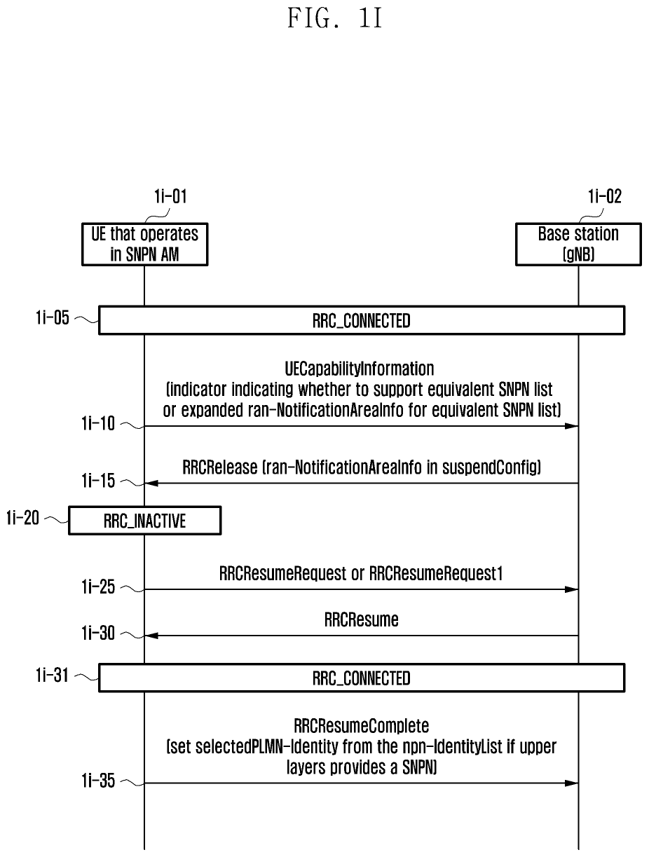

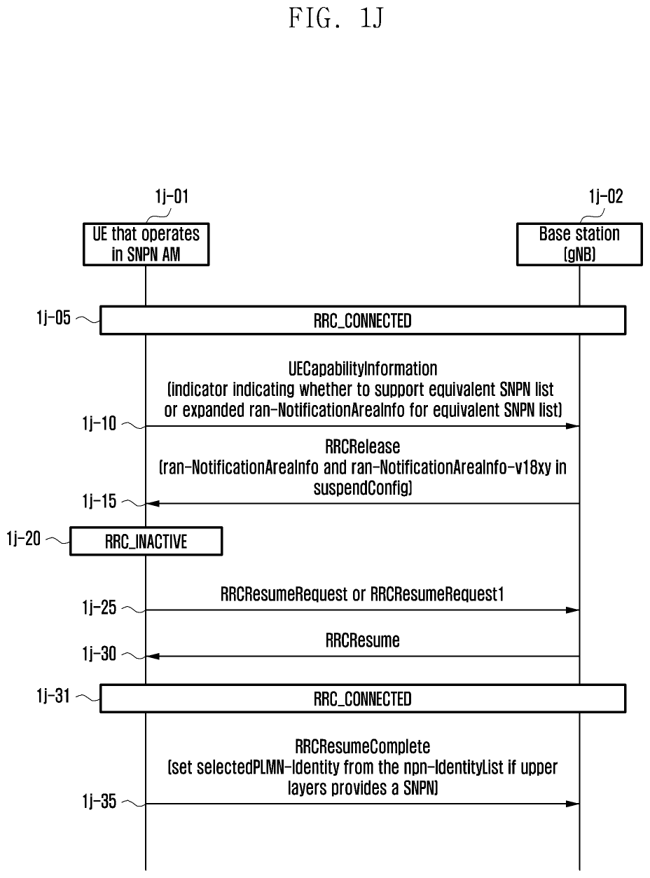

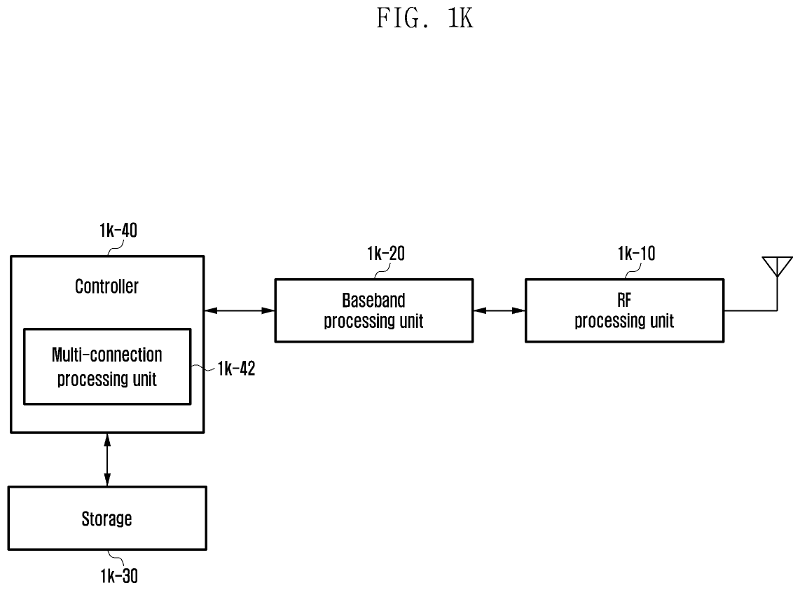

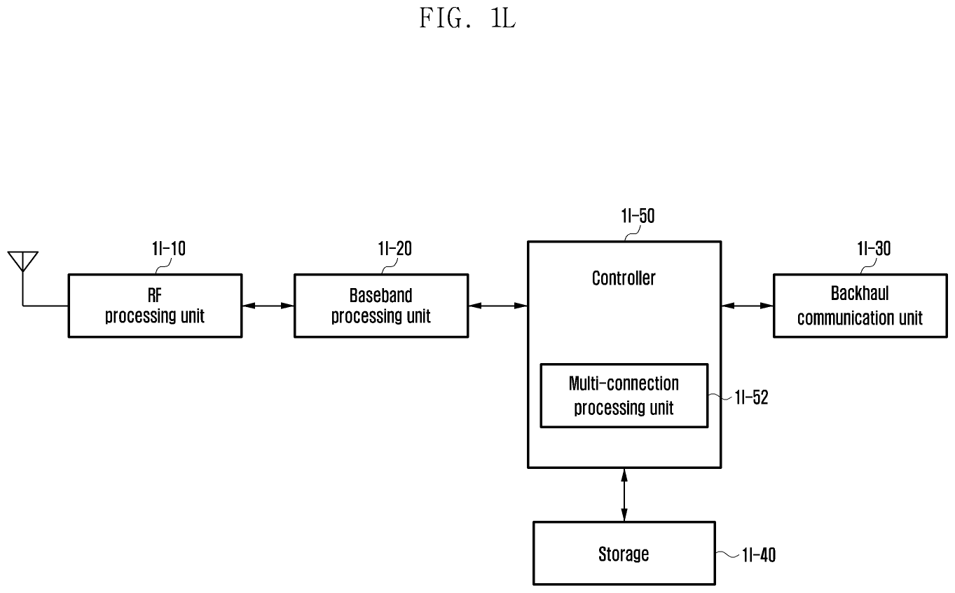

FIG. 1A illustrates a structure of a long term evolution (LTE) system for reference in describing the disclosure.

With reference to FIG. 1A, as illustrated, a wireless access network of the LTE system includes next-generation based stations (evolved node B) (hereinafter, eNB, node B, or base station) 1a-05, 1a-10, 1a-15, and 1a-20, a mobility management entity (MME) 1a-25, and a serving-gateway (S-GW) 1a-30. A user equipment (hereinafter, UE or terminal) 1a-35 accesses an external network through the eNB (1a-05 to 1a-20) and the S-GW 1a-30.

In FIG. 1A, the eNB (1a-05 to 1a-20) corresponds to the existing node B of Universal Mobile Telecommunications System (UMTS). The eNB is connected to the UE 1a-35 through a wireless channel and performs a more complex role than the existing node B. In the LTE system, all user traffic including real-time services, such as voice over Internet protocol (VOIP) through an Internet protocol, is serviced through a shared channel. Therefore, there is a need for a device that collects status information such as buffer status, available transmission power status, and channel status of UEs and performs scheduling, and the eNB (1a-05 to 1a-20) is responsible for this. A single eNB typically controls a plurality of cells. For example, to implement a transmission rate of 100 Mbps, the LTE system uses, for example, an orthogonal frequency division multiplexing (OFDM) scheme as radio access technology in the bandwidth of 20 MHz. Also, the LTE system applies an adaptive modulation & coding (AMC) scheme that determines a modulation scheme and a channel coding rate according to a channel condition of a UE. The S-GW 1a-30 is a device that provides a data bearer and generates or removes the data bearer under control of the MME 1a-25. The MME is a device that is responsible for various control functions as well as mobility management function and is connected to a plurality of base stations.

FIG. 1B illustrates a wireless protocol structure in a long term evolution (LTE) system for reference in describing the disclosure.

With reference to FIG. 1B, a wireless protocol of the LTE system includes packet data convergence protocols (PDCPs) 1b-05 and 1b-40, radio link controls (RLCs) 1b-10 and 1b-35, and medium access controls (MACs) 1b-15 and 1b-30 in a UE and an eNB, respectively. The PDCP 1b-05, 1b-40 is responsible for operations, such as IP header compression/decompressions. Main functions of the PDCP are summarized as follows.
A header compression and decompression function (Header compression and decompression: ROHC only)
A user data transmission function (Transfer of user data)
A sequential delivery function (In-sequence delivery of upper layer PDUs at PDCP re-establishment procedure for RLC AM)
A reordering function (For split bearers in DC (only support for RLC AM): PDCP PDU routing for transmission and PDCP PDU reordering for reception)
A duplicate detection function (Duplicate detection of lower layer SDUs at PDCP re-establishment procedure for RLC AM)
A retransmission function (Retransmission of PDCP SDUs at handover and, for split bearers in DC, of PDCP PDUs at PDCP data-recovery procedure, for RLC AM)
A ciphering and deciphering function (Ciphering and deciphering)
A timber-based SDU discard function (Timer-based SDU discard in uplink.)

The radio link control (RLC) 1b-10, 1b-35 reconfigures a PDCP packet data unit (PDU) to an appropriate size and performs automatic repeat request (ARQ) operations. Main functions of the RLC are summarized as follows.
A data transmission function (Transfer of upper layer PDUs)
An ARQ function (Error Correction through ARQ (only for AM data transfer))
A concatenation, segmentation, and reassembly function (Concatenation, segmentation and reassembly of RLC SDUs (only for UM and AM data transfer))
A re-segmentation function (Re-segmentation of RLC data PDUs (only for AM data transfer))
A reordering function (Reordering of RLC data PDUs (only for UM and AM data transfer))
A duplicate detection function (Duplicate detection (only for UM and AM data transfer))
An error detection function (Protocol error detection (only for AM data transfer))
An RLC SDU discard function (RLC SDU discard (only for UM and AM data transfer))
An RLC re-establishment function (RLC re-establishment)

The MAC 1b-15, 1b-30 is connected to a plurality of RLC layer devices configured in a single UE, and performs operations of multiplexing RLC PDUs to a MAC PDU and demultiplexing the RLC PDUs from the MAC PDU. Main functions of the MAC are summarized as follows.
A mapping function (Mapping between logical channels and transport channels)
   A multiplexing and demultiplexing function (Multiplexing/demultiplexing of MAC SDUs belonging to one or different logical channels into/from transport blocks (TB) delivered to/from the physical layer on transport channels)
A scheduling information report function (Scheduling information reporting)
A HARQ function (Error correction through HARQ)
A function to handle priority between logical channels (Priority handling between logical channels of one UE)
A function to handle priority between UEs (Priority handling between UEs by means of dynamic scheduling)
An MBMS service identification function (MBMS service identification)
A transport format selection function (Transport format selection)
A padding function (Padding)

The physical (PHY) layer 1b-20, 1b-25 operates to perform channel coding and modulation of upper layer data, to convert the same to an OFDM symbol and to transmit the same through a wireless channel, or to demodulate the OFDM symbol received through the wireless channel and to transmit the same to an upper layer. Also, for additional error correction, even the physical layer uses hybrid ARQ (HARQ) and a reception end transmits a reception status of a packet transmitted from a transmission end at 1 bit. This is called HARQ ACK/NACK information. Downlink HARQ ACK/NACK information on uplink transmission may be transmitted through a physical channel, a physical hybrid-ARQ indicator channel (PHICH), and uplink HARQ ACK/NACK information on downlink transmission may be transmitted through a physical channel, a physical uplink control channel (PUCCH) or a physical uplink shared channel (PUSCH).

Meanwhile, the PHY layer may include one or a plurality of frequencies/carriers, and technology for simultaneously setting and using the plurality of frequencies is called carrier aggregation (hereinafter, referred to as CA). CA technology may dramatically increase a transmission amount by the number of secondary carriers by additionally using a primary carrier and one or a plurality of secondary carriers, rather than using a single carrier for communication between a terminal (or user equipment (UE)) and a base station (E-UTRAN NodeB, eNB). Meanwhile, in LTE, a cell within a base station that uses a primary carrier is called a primary cell (PCell) and a secondary carrier is called Secondary Cell (SCell).

Although not illustrated, a radio resource control (hereinafter, referred to as RRC) layer is present as an upper layer of a PDCP layer of each of the UE and the base station, and the RRC layer may transmit and receive access and measurement related configuration control messages for radio resource control.

FIG. 1C illustrates a structure of a next-generation mobile communication system to which the disclosure applies.

With reference to FIG. 1C, as illustrated, a wireless access network of the next-generation mobile communication system includes a next-generation base station (new radio node B, hereinafter NR NB 1c-10) and an NR CN (new radio core network or next generation core network (NG CN) 1c-05). A user equipment (new radio user equipment, hereinafter, NR UE or UE 1c-15) may access an external network through the NR NB 1c-10 and the NR CN 1c-05.

In FIG. 1C, the NR NB 1c-10 corresponds to an evolved node B (eNB) of the existing LTE system. The NR NB is connected to the NR UE 1c-15 through a wireless channel and may provide a superior service than the existing node B. In the next-generation mobile communication system, all user traffic is serviced through a shared channel, so there is a need for a device that collects status information such as buffer status, available transmission power status, and channel status of UEs and performs scheduling, and the NR NB 1c-10 is responsible for this. A single NR NB controls a plurality of cells. To implement ultra-high-speed data transmission compared to existing LTE, it may have a bandwidth greater than or equal to the existing maximum bandwidth, and beamforming technology may be additionally applied by using orthogonal frequency division multiplexing (hereinafter, referred to as OFDM) as radio access technology.

Also, an adaptive modulation & coding (hereinafter, referred to as AMC) scheme that determines a modulation scheme and a channel coding rate according to a channel status of a UE is applied. The NR CN 1c-05 performs functions such as mobility support, bearer configuration, and QoS configuration.

The NR CN is a device that is responsible for various control functions as well as a mobility management function and is connected to a plurality of base stations. Also, the next-generation mobile communication system may interact with the existing LTE system and the NR CN is connected to an MME 1c-25 through a network interface. The MME is connected to the existing base station, an eNB 1c-30.

FIG. 1D illustrates a wireless protocol structure of a next-generation mobile communication system to which the disclosure may apply.

With reference to FIG. 1D, a wireless protocol of the next-generation mobile communication system includes NR service data adaptation protocols (NR SDAPs) 1d-01 and 1d-45, NR packet data convergence protocols (NR PDCPs) 1d-05 and id-40, NR radio link controls (NR RLCs) 1d-10 and 1d-35, and NR medium access controls (NR MACs) 1d-15 and 1d-30 in a UE and an NR base station (gNB), respectively.

Main functions of the NR SDAP 1d-01, 1d-45 may include some of the following functions.
A user data transmission function (transfer of user plane data)
A function of mapping a QoS flow and a data bearer for uplink and downlink (mapping between a QoS flow and a DRB for both DL and UL)
A function of marking a QoS flow ID for uplink and downlink (marking QoS flow ID in both DL and UL packets)
A function of mapping a reflective QoS flow to a data bearer for uplink SDAP PDUs (reflective QoS flow to DRB mapping for the UL SDAP PDUs).

For the SDAP layer device, the UE may receive a configuration as to whether to use a header of the SDAP layer device or a function of the SDAP layer device for each PDCP layer device, each bearer, or each logical channel through an RRC message. If the SDAP header is configured, a 1-bit indicator of non-access stratum (NAS) reflective QoS of the SDAP header and a 1 bit-indicator of AS reflective QoS may indicate that the UE may update or reconfigure information on mapping of QoS flow and a data bearer in uplink and downlink. The SDAP header may include QoS flow ID information indicating QoS. The QoS information may be used as data-processing-priority or scheduling information to support a seamless service.

Main functions of the NR PDCP 1d-05, 1d-40 may include some of the following functions.
A header compression and decompression function (Header compression and decompression: ROHC only)
A user data transmission function (Transfer of user data)
A sequential delivery function (In-sequence delivery of upper layer PDUs)
A non-sequential delivery function (Out-of-sequence delivery of upper layer PDUs)
A reordering function (PDCP PDU reordering for reception)
A duplicate detection function (Duplicate detection of lower layer SDUs)
A retransmission function (Retransmission of PDCP SDUs)
A ciphering and deciphering function (Ciphering and deciphering)
A timer-based SDU removal function (Timer-based SDU discard in uplink.)

The reordering function of the NR PDCP layer device refers to a function of sequentially reordering PDCP PDUs received from a lower layer on the basis of a PDCP sequence number (SN). More specifically, the reordering function may include a function of sequentially transferring the reordered data to an upper layer or may include a function of directly transmitting data regardless of the sequence. The reordering function may include a function of recording lost PDCP PDUs through reordering, a function of reporting the status of the lost PDCP PDUs to a transmitting side, or a function of making a request for retransmitting the lost PDCP PDUs.

Main functions of the NR RLC 1d-10, 1d-35 may include some of the following functions.
A data transmission function (Transfer of upper layer PDUs)
A sequential delivery function (In-sequence delivery of upper-layer PDUs)
A non-sequential delivery function (Out-of-sequence delivery of upper-layer PDUs)
An ARQ function (Error correction through ARQ)
A concatenation, segmentation, and reassembly function (Concatenation, segmentation and reassembly of RLC SDUs)
A re-segmentation function (Re-segmentation of RLC data PDUs)
A reordering function (Reordering of RLC data PDUs)
A duplicate detection function (Duplicate detection)
An error detection function (Protocol error detection)
An RLC SDU deletion function (RLC SDU discard)
An RLC reestablishment function (RLC reestablishment)

The sequential delivery function (in-sequence delivery) of the NR RLC device refers to a function of sequentially transmitting RLC SDUs received from a lower layer to an upper layer. More specifically, when one original RLC SDU is divided into a plurality of RLC SDUs and then received, the sequential delivery function (in-sequence delivery) of the NR RLC device may include a function of reassembling and transmitting the RLC SDUs, a function of reordering the received RLC PDUs on the basis of an RLC SN or a PDCP SN, a function of recording lost RLC PDUs through the reordering, a function of reporting the status of the lost RLC PDUs to a transmitting side, a function of making a request for retransmitting the lost RLC PDUs, a function of when there are lost RLC SDUs, sequentially transferring only RLC SDUs preceding the lost RLC SDUs to the upper layer, a function of, if a predetermined timer expires even though there are lost RLC SDUs, sequentially transferring all RLC SDUs received before the timer starts to the upper layer, or a function of, if a predetermined timer expires even though there are lost RLC SDUs, sequentially transferring all RLC SDUs received up to now to the upper layer.

Also, the NR RLC device may process the RLC PDUs sequentially in order in which they are received (according to arrival order regardless of serial number or sequence number) and may transfer the RLC PDUs to a PDCP device regardless of the sequence thereof (out-of-sequence delivery). In the case of segments, the NR RLC device may receive segments that are stored in a buffer or are to be received in the future, reconfigure the segments to be one RLC PDU, process the RLC PDU, and then transmit the same to the PDCP device. The NR RLC layer may not include a concatenation function, and the function may be performed by an NR MAC layer, or may be replaced with a multiplexing function of the NR MAC layer.

The non-sequential delivery function (out-of-sequence delivery) of the NR RLC device refers to a function of transferring RLC SDUs received from the lower layer directly to the upper layer regardless of the sequence of the RLC SDUs, and may include a function of, when one original RLC SDU is divided into a plurality of RLC SDUs and then received, reassembling and transmitting the RLC PDUs and a function of storing RLC SNs or PDCP SNs of the received RLC PDUs, reordering the RLC PDUs, and recording lost RLC PDUs.

The NR MAC (1d-15, 1d-30) may be connected to a plurality of NR RLC layer devices configured in one UE and main functions of the NR MAC may include some of the following functions.
A mapping function (Mapping between logical channels and transport channels)
   A multiplexing and demultiplexing function (Multiplexing/demultiplexing of MAC SDUs)
A scheduling information report function (Scheduling information reporting)
A HARQ function (Error correction through HARQ)
A function to handle priority between logical channels (Priority handling between logical channels of one UE)
A function to handle priority between UEs (Priority handling between UEs by means of dynamic scheduling)
   An MBMS service identification function (MBMS service identification)
A transport format selection function (Transport format selection)
A padding function (Padding)

An NR PHY layer 1d-20, 1d-25 performs an operation for channel-coding and modulating upper layer data to generate an OFDM symbol and transmitting the OFDM symbol through a wireless channel or demodulating and channel-decoding the OFDM symbol received through the wireless channel and transmitting the demodulated and channel-decoded OFDM symbol to the upper layer.

FIG. 1E illustrates a procedure for a UE in an RRC idle state (RRC_IDLE) to access a stand-alone non-public network (SNPN) cell and to configure an RRC connection in a next-generation mobile communication system according to an embodiment of the disclosure.

A stand-alone non-public network (SNPN) may represent a network that is operated by a non-public network (NPN) operator, without relying on network functions provided by a public land mobile network (PLMN) (SNPN is operated by an NPN operator and not relying on network functions provided by a PLMN).

Therefore, a UE that operates in an SNPN access mode (hereinafter, AM) may perform an SNPN selection process, without performing a normal PLMN selection process (When the UE is set to operate in SNPN access mode the UE does not perform normal PLMN selection procedures).

A UE that operates in an SNPN access mode may receive available one or a plurality of PLMN IDs and available one or a plurality of network identifiers (NIDs) from system information broadcast by a cell and may apply the same to a network selection process (i.e., SNPN selection) (UEs operating in SNPN access mode read the available PLMN IDs and list of available NIDs from the broadcast system information and take them info account during network selection).

Each SNPN is identified with a single PLMN ID and NID, and an SNPN-enabled UE is configured with subscriber identifiers and credential information for one or a plurality of SNPNs, so may support the SNPN access mode (An SNPN-enabled UE is configured with subscriber identifiers and credentials for one or multiple SNPNs identified by the combination of PLMN ID and NID, so can support the SNPN access mode). This may be equally applied to an embodiment described below.

With reference to FIG. 1E, in operation 1e-05, a UE 1e-01 may be in an RRC idle state (RRC_IDLE) (1e-05).

In operation 1e-10, the UE 1e-01 in the RRC idle state may receive system information and then, in operation 1e-15, the UE 1e-01 may select an SNPN (1e-15).

More specifically, upon request from an NAS layer of the UE 1e-01, an AS layer of the UE may find available one or a plurality of SNPNs by scanning all RF channels in an NR band according to its capability (on request of the NAS in UE, the AS in UE shall scan all RF channels in the NR bands according to its capabilities to find available SNPNs).

The UE 1e-01 may find a cell with a strongest signal in each carrier and may read system information (e.g., SIB1) from the cell (1e-10) to find one or a plurality of SNPNs to which the cell belongs (On each carrier, the UE shall search for the strongest cell and read its system information, in order to find out which SNPN(s) the cell belongs to).

For reference, information on SNPN may be included in a CellAccessRelatedInfo information element stored in SIB1, and the CellAccessRelatedInfo information element may include specific information as follows.
plmn-IdentityInfoList: A list of PLMN-IdentityInfo constituted with one or a plurality of PLMN-IdentityInfo
   Each PLMN-IdentityInfo may include at least one field, such as a field that contains one or a plurality of PLMN-Identities (plmn-IdentityList), a field that contains a tracking area code (trackingAreaCode), a field that contains a RAN area code (RAN-AreaCode) (ranac), a field that contains a cell identity (cellIdentity), a field that contains information (reserved or notReserved) indicating whether the cell is reserved for operator use (cellReservedForOperatorUse), a field indicating whether the cell supports integrated access and backhaul (LAB) and whether the cell may be selected or reselected for an IAB node (iab-support), and a field that contains information on the length of a base station ID (gNB-ID-Length).
cellReservedForOtherUse: An indicator indicating whether the cell is reserved for other use
cellReservedForFurtherUse: An indicator whether the cell is reserved for future use
npn-IdentityInfoList: NPN-IdentityInfoList constituted with one or a plurality of NPN-IdentityInfo
   Each NPN-IdentityInfo may include at least one field, such as a field that contains one or a plurality of NPN-Identities (npn-IdentityList), a field that contains a tracking area code (trackingAreaCode), a field that contains a RAN area code (RAN-AreaCode) (ranac), a field that contains a cell identity (cellIdentity), a field that contains information (reserved or notReserved) indicating whether the cell is reserved for operator use (cellReservedForOperatorUse), a field indicating whether the cell supports integrated access and backhaul (IAB) and whether the cell may be selected or reselected for an IAB node (iab-support), and a field that contains information on the length of a base station ID (gNB-ID-Length). NPN-Identity may be constituted with a closed access group (CAG) ID list or an NID ID list for each PLMN-Identity. Specifically, NPN-Identity may have ASN.1 structure as follows.

| | |
|---|---|
| NPN-Identity-r16 | CHOICE { |
| [symbol] 16 | SEQUENCES { |
| plmn.Identity-r16 | PLMN-Identity |
| cag-IdentityList-r16 | SEQUENCE (SIZE [symbol] |
| snpn-r16 | SEQUENCE { |
| plmn.Identity-r16 | PLMN-Identity |
| nid-List-r16 | SEQUENCE (SIZE [symbol] |
| } | |
| } | |
| CAG-Identity [symbol] | SEQUENCE { |
| cag-Identity-r16 | BIT STRING (SIZE (32 [symbol] |
| [symbol] | ENUMERATED [symbol] OPTIONAL --Need.R |
| } | |
| NID-r16 | BIT STRING((SIZE (44)) |

[symbol]

indicates data missing or illegible when filed

If one or a plurality of SNPN identities are read in a cell with a strongest signal, the AS layer of the UE may report each read SNPN to the NAS layer of the UE (If the UE can read one or several SNPN identities in the strongest cell, each found SNN shall be reported to the NAS).

In the case of manually selecting an SNPN, the AS layer of the UE may report available SNPN identifiers to the NAS layer of the UE upon request from the NAS layer of the UE, and here, if a human-readable network name (HRNN) is broadcast from system information, the AS layer of the UE may report the received HRNN to the NAS layer of the UE together with available SNPN identifiers (For manual selection, UE shall upon request by NAS report available SNPN identifiers together with their HRNN (if broadcast) to the NAS). Of course, upon request from the NAS layer of the UE, the AS layer of the UE may stop searching for available SNPNs (The search for available SNPNs may be stopped on request of the NAS).

The AS layer UE may optimize SNPN search using stored information (e.g., frequencies and, optionally, cell parameters contained in previously received measurement control information elements) (The UE may optimise SNPN search by using stored information e.g. frequencies and optionally also information on cell parameters from previously received measurement control information elements).

In 1e-15, using reporting information of the AS layer UE, the NAS layer of the UE may select the SNPN (1e-15) and may inform this to the AS layer device of the UE (If NAS has selected a SNPN and provided this selection to AS).

In operation 1e-20, the UE 1e-01 that has selected the SNPN may perform a cell selection procedure based on system information (e.g., which may include MIB or SIB1) received in operation 1e-10 to select a suitable cell. The UE that operates in the SNPN access mode may consider a cell that satisfies the following conditions as the suitable cell.
Condition 1: A case in which the cell belongs to a UE selected SNPN or a registered SNPN (The cell is part of either the selected SNPN or the registered SNPN of the UE)
Condition 2: A case in which the cell satisfies cell selection criteria
   The cell selection criteria refer to Equation 1 below.

$$Srxlev > 0 AND Squal > 0 \qquad Equation 1$$

$$where :$$

$$Srxlev = Qrxlevmeas - ( Qrxlev min + Qrxlev min offset ) - Pcompensation - Qoffsettemp$$

$$Squal = Qqualmeas - ( Qqual min + Qqual min offset ) - Qoffsettemp$$

Definition of parameters used in the above Equation 1 may be referenced from the 3GPP standard document “Equipment (UE) procedures in idle mode”, and the parameters may be included in system information (e.g., SIB1, SIB2) broadcast by the cell. In the following, the same applies to embodiments of the disclosure to which Equation 1 applies.
Condition 3: A case in which the cell is not barred according to the most recent information provided from a non-access stratum (NAS) device (The cell is not barred) and, in the cell, at least one tracking area (TA) does not belong to a list of forbidden tracking areas for the SNPN that satisfies Condition 1 (The cell is part of at least one TA that is not part of the list of “Forbidden Tracking Areas” which belongs to either the selected SNPN or the registered SNPN of the UE)
   A case in which the cell is barred may include, for example, a case in which a ‘cellBarred’ directive is set to “barred” in at least MIB, a case in which a Rel-16 “cellReservedForOperatorUse” directive is set to “reserved” in SIB1, or a case in which a “Rel-16cellReservedForFutureUse” directive is set to “reserved”.

In operation 1e-25, the UE 1e-01 operating in the SNPN access mode that camps on the suitable cell may reselect a cell based on system information (e.g., SIB2, SIB3, SIB4, SIB5, SIB6) that includes cell reselection parameters.

In 1e-30 operation, the UE 1e-01 that operates in the SNPN access mode may transmit an RRC connection request message (RRCSetupRequest) to configure an RRC connection with a base station 1e-02. The message may include an identity of the UE (ue-Identity) and a cause for establishing the RRC connection (establishmentCause).

In operation 1e-35, the base station 1e-02 that successfully receives the RRC connection establishment request message may transmit an RRC connection configuration message (RRCSetup) to the UE. The message may include radio resource configuration information (radioBearerConfig) and master cell group configuration information (masterCellGroup). When the UE 1e-01 successfully receives the RRC connection configuration message, the UE 1e-01 may apply configuration information included in the message and may switch to an RRC connected mode in operation 1e-36 (1e-36), and may consider a current cell as a primary cell (PCell).

In operation 1e-40, the UE 1e-01 that switches to the RRC connected mode may transmit an RRC connection configuration complete message (RRCSetupComplete) to the base station 1e-02. The message may contain dedicatedNAS-Message (e.g., RegistrationRequest including NID) to include information received from an upper layer device of the UE.

If the NAS layer device of the UE selects an SNPN, the UE may include, in the message, selectedPLMN-Identity from npn-IdentityInfoList broadcast from SIB1 (if upper layers selected an SNPN, the UE shall set the selectedPLMN-Identity from the npn-IdentityInfoList). The selectedPLMN-Identity indicates an index in which the UE selects a network from the npn-IdentityInfoList in SIB1 (PLMN identified by a PLMN identity in plmn-IdentityList or PNI-NPN identified by a PLMN identity and a CAG-ID or SNPN identified by a PLMN identity and a NID), and the UE may set selectedPLMN-Identity as described below.
A PLMN index to indicate a specific PLMN is defined as b1+b2+ . . . +b(n−1)+i in which n denotes an n-th entry of PLMN-IdentityInfoList, i denotes an i-th entry included in its corresponding PLMN-IdentityInfo, and b(j) denotes the number of PLMN-Identity entries included in each PLMN-IdentityInfo (The PLMN index is defined as b1+b2+ . . . for the PLMN included at the n-th entry of PLMN-IdentityInfoList and the i-th entry of its corresponding PLMN-IdentityInfo, where b(j) is the number of PLMN-Identity entries in each PLMN-IdentityInfo, respectively). For example, the UE may set selectedPLMN-Identity as shown in Table 1 below.

TABLE 1
PLMN-IdentityInfoList = {PLMN-IdentityInfo 1, PLMN-IdentityInfo 2}
- PLMN-IdentityInfo 1 = {PLMN-Identity A}
- PLMN-IdentityInfo 2 = {PLMN-Identity B, PLMN-Identity C}
If PLMN Identity A is selected, then selectedPLMN-Identity = b(1) = 1.
If PLMN Identity B is selected, then selectedPLMN-Identity = b(1)+b(2) = 2.
If PLMN Identity C is selected, then selectedPLMN-Identity = b(1)+b(2)+b(3) = 3.

For reference, PLMN-IdentityInfoList has the feature of being broadcast from SIB1 at all times.
An NPN index to indicate a specific NPN identity is defined as B+c1+c2+ . . . +c(n−1)+d1+d2+ . . . +d(m−1)+e(i) in which n denotes an n-th entry of NPN-IdentityInfoList, m denotes an n-th entry of npn-IdentityList within its corresponding NPN-IdentityInfoList entry, and i denotes an i-th entry of its corresponding NPN-Identity (The NPN index is defined as B+c1+c2+ . . . the NPN identity included in the n-th entry of NPN-IdentityInfoList and in the m-th entry of npn-Identitylist within that NPN-IdentityInfoList entry, and the i-th entry of its corresponding NPN-Identity). Here, each of values may be defined as follows.
   B denotes an index used to indicate a last PLMN in PLMN-IdentityInfoList. If the cell is an NPN-only cell (if a cellReservedForOtherUse directive is set to true and npn-IdentityInfoList is present in CellAccessRelatedInfo, it may be an NPN-only cell), B may be 0.
   c(j) denotes the number of NPN index values used in a j-th NPN-IdentityInfoList entry, and d(k) denotes the number of NPN index values used in a k-th npn-IdentityList within an n-th NPN-IdentityInfoList entry. That is, e(i) may be differently defined in SNPN(s) and PNI-NPN(s) (public network integrated NPN). That is, e(i) may be defined as i if the n-th entry of the NPN-IdentityInfoList entry is for SNPN(s), and may be defined as 1 if the n-th entry of the NPN-IdentityInfoList entry is for PNI-NPN(s).

For example, the UE may set selectedPLMN-Identity as shown in Table 2 or Table 3 below.

TABLE 2
cellReservedForOtherUse is absent in SIB1

```
PLMN-IdentityInfoList = {PLMN-IdentityInfo 1, PLMN-IdentityInfo 2}
  - PLMN-IdentityInfo 1 = {PLMN-Identity A}
  - PLMN-IdentityInfo 2 = {PLMN-Identity B, PLMN-Identity C}
NPN-IdentityInfoList = {NPN-IdentityInfo 1, NPN-IdentityInfo 2}
  - NPN-IdentityInfo 1 = NPN-Identity K (pni-npn)
    ▪ NPN-Identity K = PLMN-Identity D + {cag-Identity v, cag-Identity y}
  - NPN-IdentityInfo 2 = NPN-Identity J + NPN-Identity K
    ▪ NPN-Identity J = PLMN-Identity E + {NID a, NID b}
    ▪ NPN-Identity K = PLMN-Identity F + {NID c, NID d}
If PLMN Identity A is selected, then selectedPLMN-Identity = b(1) = 1.
If PLMN Identity B is selected, then selectedPLMN-Identity = b(1)+b(2)= 2.
If PLMN Identity C is selected, then selectedPLMN-Identity = b(1)+b(2)+b(3) = 3.
If PLMN Identity D + cag-Identity v or PLMN Identity D + cag-Identity y is selected, then selectedPLMN-Identity = B+e(i) = 3+1
= 4
If PLMN-Identity E + NID a is selected, then selectedPLMN-Identity = B+c(1)+e(1) = 3+1+1 = 5
If PLMN-Identity E + NID b is selected, then selectedPLMN-Identity = B+c(1)+e(2) = 3+1+2 = 6
If PLMN-Identity F + NID c is selected, then selectedPLMN-Identity = B+c(1)+d(1)+e(1)= 3+1+2+1 = 7
If PLMN-Identity F + NID d is selected, then selectedPLMN-Identity = B+c(1)+d(1)+e(2)= 3+1+2+2 = 8
```

TABLE 3
cellReservedForOtherUse is set to true in SIB1

```
PLMN-IdentityInfoList = {PLMN-IdentityInfo}
  - PLMN-IdentityInfo 1 = {PLMN-Identity A}
NPN-IdentityInfoList = {NPN-IdentityInfo 1, NPN-IdentityInfo 2}
  - NPN-IdentityInfo 1 = NPN-Identity K (pni-npn)
    ▪ NPN-Identity K = PLMN-Identity D + {cag-Identity v, cag-Identity y)
  - NPN-IdentityInfo 2 = NPN-Identity J + NPN-Identity K
    ▪ NPN-Identity J = PLMN-Identity E + {NID a, NID b}
    ▪ NPN-Identity K = PLMN-Identity F + {NID c, NID d}
If PLMN Identity D + cag-Identity v or PLMN Identity D + cag-Identity y is selected, then selectedPLMN-Identity = B+e(i) = 0+1
= 1
If PLMN-Identity E + NID a is selected, then selectedPLMN-Identity = B+c(1)+e(1) = 0+1+1 = 2
If PLMN-Identity E + NID b is selected, then selectedPLMN-Identity = B+c(1)+e(2) = 0+1+2 = 3
If PLMN-Identity F + NID c is selected, then selectedPLMN-Identity = B+c(1)+d(1)+e(1)= 0+1+2+1 = 4
If PLMN-Identity F + NID d is selected, then selectedPLMN-Identity = B+c(1)+d(1)+e(2)= 0+1+2+2 = 5
```

In operation 1e-45, the base station 1e-02 may transmit the dedicatedNAS message (e.g., RegistrationRequest) received from the UE 1e-01 in operation 1e-40 to core equipment, an access and mobility management function (AMF) 1e-03. The message may include an NID in SNPN information selected by the UE.

In operation 1e-50, the AMF 1e-03 may transmit a RegistrationAccept message to the UE 1e-01 through the base station 1e-02. The message may include the NID. That is, through this, the UE may register the selected SNPN, and it may become the registered SNPN.

A UE that operates in an SNPN access mode according to an embodiment of the disclosure may select an SNPN and the selected SNPN may be registered. However, the UE has the feature of not supporting an equivalent SNPN list. The equivalent SNPN list may represent an SNPN list that the UE may consider as the same SNPN as the registered SNPN for cell selection, cell reselection, and handover according to information provided from non-access stratum (NAS) (Equivalent SNPN list is a list of SNPNs considered as equivalent by the UE for cell selection, cell reselection, and handover according to the information provided by NAS).

FIG. 1F illustrates a procedure for a UE in an RRC inactive state (RRC_INACTIVE) to access a stand-alone non-public network (SNPN) cell and to resume an RRC connection in a next-generation mobile communication system according to an embodiment of the disclosure.

With reference to FIG. 1F, in operation 1f-05, a UE 1f-01 may configure an RRC connection with a base station 1f-02 and may be in an RRC connected mode (RRC_CONNECTED) (1f-05). The UE 1f-01 may be a UE that operates in an SNPN access mode according to the above-described embodiment.

In operation 1f-10, the base station 1f-02 may transmit, to the UE 1f-01, an RRC connection release message (RRCRelease) that contains suspend configuration information (suspendConfig). RAN notification area information (RAN-NotificationAreaInfo) may be configured in the suspend configuration information through a RAN notification area information field (ran-NotificationAreaInfo), and one of fields, a cell list (cellList) and a RAN area configuration list (ran-AreaConfigList), may be configured in the RAN notification area information.
cellList: A PLMN-RAN-AreaCellList information element may be included, and this may be constituted with one or a plurality of PLMN-RAN-AreaCell information elements.
   Each PLMN-RAN-AreaCell information element may be constituted with a plmn-Identity field and a ran-AreaCells field. The plmn-Identity field may optionally include a PLMN identity (PLMN-Identity). The ran-AreaCells field may include one or a plurality of cell identities (CellIdentity). The base station may not include the plmn-Identity field for a UE that operates in an SNPN access mode (plmn-Identity field is not included for UE in SNPN access mode). Here, the base station may configure one or a plurality of cell identities included in the ran-AreaCells field to belong to a registered SNPN at all times (the ran-AreaCells always belongs to the registered SNPN for UE in SNPN Access mode).
ran-AreaConfigList: A PLMN-RAN-AreaConfigList information element may be included, and this may be constituted with one or a plurality of PLMN-RAN-AreaConfig information elements.
   Each PLMN-RAN-AreaConfig information element may be constituted with a single plmn-Identity field and ran-Area field. The plmn-Identity field may optionally include a PLMN identity (PLMN-Identity). The ran-Area field may include one or a plurality of RAN-AreaConfig information elements. Each RAN-AreaConfig information element may be constituted with a tracking area code (TrackingAreaCode) and one or a plurality of RAN area codes (RAN-AreaCode). For reference, one or a plurality of RAN area codes may be optionally included. The base station may not include the plmn-Identity field for the UE that operates in the SNPN access mode (plmn-Identity field is not included for UE in SNPN access mode). Here, the base station may configure one or a plurality of RAN-AreaConfig information elements included in the ran-Area field to belong to the registered SNPN at all times (the ran-Area always belongs to the registered SNPN for UE in SNPN Access mode).

In operation 1f-15, the UE 1f-01 may apply the received RRC connection release message and may shift to an RRC inactive state (RRC_INACTIVE).

In operation 1f-20, the UE 1f-01 may transmit an RRC connection resume request message (RRCResumeRequest or RRCResumeRequest1) to resume the RRC connection with the base station 1f-02.

In operation 1f-25, the base station 1f-02 that successfully receives the RRC connection resume request message may transmit an RRC connection resume message (RRCResume) to the UE 1f-01. In the case of successfully receiving the RRC connection resume message, the UE may apply configuration information included in the message and may switch to an RRC connected mode (1f-26), and may consider a current cell as a primary cell (PCell).

In operation 1f-30, the UE 1f-01 that switches to the RRC connected mode may transmit an RRC connection resume complete message (RRCResumeComplete) to the base station 1f-02. For reference, selectedPLMN-Identity is not included in the message.

A UE that operates in an SNPN access mode according to an embodiment of the disclosure has the feature of not supporting an equivalent SNPN list. Therefore, when the base station configures RAN notification area information to the UE, the base station has the feature of configuring RAN notification area information to the UE such that ran-Area or ran-AreaCells may belong to a registered SNPN at all times without including a plmn-Identity field regardless of whether to configure RAN notification area information to a cell list field or a RAN area configuration list field. That is, the base station has the advantage of reducing signaling for configuring RAN notification area information by not including a separate NID in the RAN notification area information.

FIG. 1G illustrates a procedure for a UE in an RRC idle state (RRC_IDLE) to access a stand-alone non-public network (SNPN) cell and to configure an RRC connection in a next-generation mobile communication system according to an embodiment of the disclosure.

With reference to FIG. 1G, in operation 1g-05, a UE 1g-01 may be in an RRC idle state (RRC_IDLE) (1g-05).

In operation 1g-10, the UE 1g-01 in the RRC idle state may receive system information. In operation 1g-15, the UE 1g-01 may select an SNPN.

More specifically, upon request from a NAS layer of the UE, an AS layer of the UE may find available one or a plurality of SNPNs by scanning all RF channels in an NR band according to its capability (on request of the NAS in UE, the AS in UE shall scan all RF channels in the NR bands according to its capabilities to find available SNPNs). The UE may find a cell with a strongest signal in each carrier and may read system information (e.g., SIB1) from the cell (1g-10) to find one or a plurality of SNPNs to which the cell belongs (On each carrier, the UE shall search for the strongest cell and read its system information, in order to find out which SNPN(s) the cell belongs to). For reference,
information on SNPN may be included in a CellAccessRelatedInfo information element stored in SIB1, and the CellAccessRelatedInfo information element may include specific information as follows: plmn-IdentityInfoList: PLMN-IdentityInfo list constituted with one or a plurality of PLMN-IdentityInfo
   Each PLMN-IdentityInfo may include at least one field, such as a field that contains one or a plurality of PLMN-Identities (plmn-IdentityList), a field that contains a tracking area code (trackingAreaCode), a field that contains a RAN area code (RAN-AreaCode) (ranac), a field that contains a cell identity (cellIdentity), a field that contains information (reserved or notReserved) indicating whether the cell is reserved for operator use (cellReservedForOperatorUse), a field indicating whether the cell supports integrated access and backhaul (IAB) and whether the cell may be selected or reselected for an IAB node (iab-support), and a field that contains information on the length of a base station ID (gNB-ID-Length).
cellReservedForOtherUse: An indicator indicating whether the cell is reserved for other use
cellReservedForFurtherUse: An indicator whether the cell is reserved for future use
npn-IdentityInfoList: NPN-IdentityInfoList constituted with one or a plurality of NPN-IdentityInfo
   Each NPN-IdentityInfo may include at least one field, such as a field that contains one or a plurality of NPN-Identities (npn-IdentityList), a field that contains a tracking area code (trackingAreaCode), a field that contains a RAN area code (RAN-AreaCode) (ranac), a field that contains a cell identity (cellIdentity), a field that contains information (reserved or notReserved) indicating whether the cell is reserved for operator use (cellReservedForOperatorUse), a field indicating whether the cell supports integrated access and backhaul (IAB) and whether the cell may be selected or reselected for an IAB node (iab-support), and a field that contains information on the length of a base station ID (gNB-ID-Length). NPN-Identity may be constituted with a closed access group (CAG) ID list or an NID ID list for each PLMN-Identity. Specifically, NPN-Identity may have ASN.1 structure as follows.

| | |
|---|---|
| NPN-Identity-r16 | CHOICE { |
| [symbol] 16 | SEQUENCES { |
| plmn.Identity-r16 | PLMN-Identity |
| cag-IdentityList-r16 | SEQUENCE (SIZE [symbol] |
| snpn-r16 | SEQUENCE { |
| plmn.Identity-r16 | PLM- Identity |
| nid-List-r16 | SEQUENCE (SIZE [symbol] |
| } | |
| } | |
| CAG-IdentityInfo-r16 | SEQUENCE { |
| cag-Identity-r16 | BIT STRING (SIZE (32 [symbol] |
| [symbol] | ENUMERATED [symbol] OPTIONAL --Need.R |
| } | |
| NID-r16 | BIT STRING((SIZE (44)) |

[symbol]

indicates data missing or illegible when filed

If one or a plurality of SNPN identities are read in a cell with a strongest signal, the AS layer of the UE may report each read SNPN to the NAS layer of the UE (If the UE can read one or several SNPN identities in the strongest cell, each found SNN shall be reported to the NAS).

In the case of manually selecting an SNPN, the AS layer of the UE may report available SNPN identifiers to the NAS layer of the UE upon request from the NAS layer of the UE, and here, if a human-readable network name (HRNN) is broadcast from system information, the AS layer of the UE may report the received HRNN to the NAS layer of the UE together with available SNPN identifiers (For manual selection, UE shall upon request by NAS report available SNPN identifiers together with their HRNN (if broadcast) to the NAS).

Of course, upon request from the NAS layer of the UE, the AS layer of the UE may stop searching for available SNPNs (The search for available SNPNs may be stopped on request of the NAS).

The AS layer UE may optimize SNPN search using stored information (e.g., frequencies and, optionally cell, parameters contained in previously received measurement control information elements) (The UE may optimise SNPN search by using stored information e.g. frequencies and optionally also information on cell parameters from previously received measurement control information elements).

Using reporting information of the AS layer UE, the NAS layer of the UE may select the SNPN (1g-15) and may inform this to the AS layer device of the UE (If NAS has selected a SNPN and provided this selection to AS).

In operation 1g-20, the UE 1g-01 that has selected the SNPN may perform a cell selection procedure based on system information (e.g., MIB and SIB1) received in operation 1g-10 to select a suitable cell. The UE that operates in the SNPN access mode may consider a cell that satisfies the following conditions as the suitable cell.
Condition 1: A case in which the cell belongs to a UE selected SNPN, a registered SNPN, or an SNPN included in an equivalent SNPN list (The cell is part of either the selected SNPN or the registered SNPN or SNPN of the Equivalent SNPN list of the UE)
Condition 2: A case in which the cell satisfies cell selection criteria
   The cell selection criteria refer to Equation 1 below.

$$Srxlev > 0 AND Squal > 0 \qquad Equation 1$$

$$where :$$

$$Srxlev = Qrxlevmeas - ( Qrxlev min + Qrxlev min offset ) - Pcompensation - Qoffsettemp$$

$$Squal = Qqualmeas - ( Qqual min + Qqual min offset ) - Qoffsettemp$$

Definition of parameters used in the above Equation 1 may be referenced from the 3GPP standard document “Equipment (UE) procedures in idle mode”, and the parameters may be included in system information (e.g., SIB1, SIB2) broadcast by the cell. In the following, the same applies to embodiments of the disclosure to which Equation 1 applies.
Condition 3: A case in which the cell is not barred according to the most recent information provided from a non-access stratum (NAS) device (The cell is not barred) and, in the cell, at least one tracking area (TA) does not belong to a list of forbidden tracking areas for the SNPN that satisfies Condition 1 (The cell is part of at least one TA that is not part of the list of “Forbidden Tracking Areas” which belongs to either the selected SNPN or the registered SNPN of the UE)
   A case in which the cell is barred may include, for example, a case in which a ‘cellBarred’ directive is set to “barred” in at least MIB, a case in which a Rel-16 “cellReservedForOperatorUse” directive is set to “reserved” in SIB1, or a case in which a “Rel-16cellReservedForFutureUse” directive is set to “reserved”.

In operation 1g-25, the UE 1g-01 operating in the SNPN access mode that camps on the suitable cell may reselect a cell based on system information (e.g., SIB2, SIB3, SIB4, SIB5, SIB6) that includes cell reselection parameters.

In operation 1g-30, the UE 1g-01 that operates in the SNPN access mode may transmit an RRC connection request message (RRCSetupRequest) to configure an RRC connection with a base station 1g-02. The message may include an identity of the UE (ue-Identity) and a cause for establishing the RRC connection (establishmentCause).

In operation 1g-35, the base station 1g-02 that successfully receives the RRC connection establishment request message may transmit an RRC connection configuration message (RRCSetup) to the UE. The message may include radio resource configuration information (radioBearerConfig) and master cell group configuration information (masterCellGroup). When the UE 1g-01 successfully receives the RRC connection configuration message, the UE 1g-01 may apply configuration information included in the message and may switch to an RRC connected mode in operation 1g-36, and may consider a current cell as a primary cell (PCell).

In operation 1g-40, the UE 1g-01 that switches to the RRC connected mode may transmit an RRC connection configuration complete message (RRCSetupComplete) to the base station 1g-02. The message may contain dedicatedNAS-Message (e.g., RegistrationRequest including NID) to include information received from an upper layer device of the UE.

If the NAS layer device of the UE 1g-01 selects an SNPN, the UE may include, in the message, selectedPLMN-Identity from npn-IdentityInfoList broadcast from SIB1 (if upper layers selected an SNPN, the UE shall set the selectedPLMN-Identity from the npn-IdentityInfoList). Alternatively, when including selectedPLMN-Identity, the UE 1g-01 may also consider an equivalent SNPN list. The selectedPLMN-Identity indicates an index selected or registered by the UE from npn-IdentityInfoList in SIB1 or of its corresponding network (PLMN identified by a PLMN identity in plmn-IdentityList or PNI-NPN identified by a PLMN identity and a CAG-ID or SNPN identified by a PLMN identity and a NID), and the UE may set selectedPLMN-Identity as described below.
A PLMN index to indicate a specific PLMN is defined as b1+b2+ . . . +b(n−1)+i in which n denotes an n-th entry of PLMN-IdentityInfoList, i denotes an i-th entry included in its corresponding PLMN-IdentityInfo, and b(j) denotes the number of PLMN-Identity entries included in each PLMN-IdentityInfo (The PLMN index is defined as b1+b2+ . . . for the PLMN included at the n-th entry of PLMN-IdentityInfoList and the i-th entry of its corresponding PLMN-IdentityInfo, where b(j) is the number of PLMN-Identity entries in each PLMN-IdentityInfo, respectively). For example, the UE may set selectedPLMN-Identity as shown in Table 4 below.

```
TABLE 4
PLMN-IdentityInfoList = {PLMN-IdentityInfo 1, PLMN-IdentityInfo 2}
  - PLMN-IdentityInfo 1 = {PLMN-Identity A}
  - PLMN-IdentityInfo 2 = {PLMN-Identity B, PLMN-Identity C}
If PLMN Identity A is selected, then selectedPLMN-Identity = b(1) = 1.
If PLMN Identity B is selected, then selectedPLMN-Identity = b(1)+b(2) = 2.
If PLMN Identity C is selected, then selectedPLMN-Identity = b(1)+b(2)+b(3) = 3.
```

For reference, PLMN-IdentityInfoList has the feature of being broadcast from SIB1 at all times.
An NPN index to indicate a specific NPN identity is defined as B+c1+c2+ . . . +c(n−1)+d1+d2+ . . . +d(m−1)+e(i) in which n denotes an n-th entry of NPN-IdentityInfoList, m denotes an n-th entry of npn-IdentityList within its corresponding NPN-IdentityInfoList entry, and i denotes an i-th entry of its corresponding NPN-Identity (The NPN index is defined as B+c1+c2+ . . . the NPN identity included in the n-th entry of NPN-IdentityInfoList and in the m-th entry of npn-Identitylist within that NPN-IdentityInfoList entry, and the i-th entry of its corresponding NPN-Identity). Here, each of values may be defined as follows.
   B denotes an index used to indicate a last PLMN in PLMN-IdentityInfoList. If the cell is an NPN-only cell (if a cellReservedForOtherUse directive is set to true and npn-IdentityInfoList is present in CellAccessRelatedInfo, it may be an NPN-only cell), B may be 0.
   c(j) denotes the number of NPN index values used in a j-th NPN-IdentityInfoList entry, and d(k) denotes the number of NPN index values used in a k-th npn-IdentityList within an n-th NPN-IdentityInfoList entry. e(i) may be differently defined in SNPN(s) and PNI-NPN(s) (public network integrated NPN). That is, e(i) may be defined as i if the n-th entry of the NPN-IdentityInfoList entry is for SNPN(s), and may be defined as 1 if the n-th entry of the NPN-IdentityInfoList entry is for PNI-NPN(s).

For example, the UE may set selectedPLMN-Identity as shown in Table 5 or Table 6 below.

TABLE 5
cellReservedForOtherUse is absent in SIB1

PLMN-IdentityInfoList = {PLMN-IdentityInfo 1, PLMN-IdentityInfo 2}

| | |
|---|---|
| - | PLMN-IdentityInfo 1 = {PLMN-Identity A} |
| - | PLMN-IdentityInfo 2 = {PLMN-Identity B, PLMN-Identity C} |

NPN-IdentityInfoList = {NPN-IdentityInfo 1, NPN-IdentityInfo 2}

| - | NPN-IdentityInfo 1 = NPN-Identity K (pni-npn) | |
|---|---|---|
| | ▪ | NPN-Identity K = PLMN-Identity D + {cag-Identity v, cag-Identity y} |
| - | NPN-IdentityInfo 2 = NPN-Identity J + NPN-Identity K | |
| | ▪ | NPN-Identity J = PLMN-Identity E + {NID a, NID b} |
| | ▪ | NPN-Identity K = PLMN-Identity F + {NID c, NID d} |

If PLMN Identity A is selected, then selectedPLMN-Identity = b(1) = 1.
If PLMN Identity B is selected, then selectedPLMN-Identity = b(1)+b(2)= 2.
If PLMN Identity C is selected, then selectedPLMN-Identity = b(1)+b(2)+b(3) = 3.
If PLMN Identity D + cag-Identity v or PLMN Identity D + cag-Identity y is selected, then
selectedPLMN-Identity = B+e(i) = 3+1 = 4
If PLMN-Identity E + NID a is selected, then selectedPLMN-Identity = B+c(1)+e(1) = 3+1+1 = 5
If PLMN-Identity E + NID b is selected, then selectedPLMN-Identity = B+c(1)+e(2) = 3+1+2 = 6
If PLMN-Identity F + NID c is selected, then selectedPLMN-Identity = B+c(1)+d(1)+e(1)=
3+1+2+1 = 7
If PLMN-Identity F + NID d is selected, then selectedPLMN-Identity = B+c(1)+d(1)+e(2)=
3+1+2+2 = 8

TABLE 6
cellReservedForOtherUse is set to true in SIB1

PLMN-IdentityInfoList = {PLMN-IdentityInfo}

| | |
|---|---|
| - | PLMN-IdentityInfo 1 = {PLMN-Identity A} |

NPN-IdentityInfoList = {NPN-IdentityInfo 1, NPN-IdentityInfo 2}

| - | NPN-IdentityInfo 1 = NPN-Identity K (pni-npn) | |
|---|---|---|
| | ▪ | NPN-Identity K = PLMN-Identity D + {cag-Identity v, cag-Identity y} |
| - | NPN-IdentityInfo 2 = NPN-Identity J + NPN-Identity K | |
| | ▪ | NPN-Identity J = PLMN-Identity E + {NID a, NID b} |
| | ▪ | NPN-Identity K = PLMN-Identity F + {NID c, NID d} |

If PLMN Identity D + cag-Identity v or PLMN Identity D + cag-Identity y is selected, then
selectedPLMN-Identity = B+e(i) = 0+1 = 1
If PLMN-Identity E + NID a is selected, then selectedPLMN-Identity = B+c(1)+e(1) = 0+1+1 = 2
If PLMN-Identity E + NID b is selected, then selectedPLMN-Identity = B+c(1)+e(2) = 0+1+2 = 3
If PLMN-Identity F + NID c is selected, then selectedPLMN-Identity = B+c(1)+d(1)+e(1)= 0+1+2+1 = 4
If PLMN-Identity F + NID d is selected, then selectedPLMN-Identity = B+c(1)+d(1)+e(2)= 0+1+2+2 = 5

In operation 1g-45, the base station 1g-02 may transmit the dedicatedNAS message (e.g., RegistrationRequest) received from the UE 1g-01 in operation 1g-40 to core equipment, an access and mobility management function (AMF) 1g-03. The message may include an NID in SNPN information selected by the UE.

In operation 1g-50, the AMF 1g-03 may transmit a RegistrationAccept message to the UE 1g-01 through the base station 1g-02. The message may include the NID. That is, through this, the UE may register the selected SNPN, and it may become the registered SNPN. Additionally, the message may include an equivalent SNPN list.

A UE that operates in an SNPN access mode according to an embodiment of the disclosure may select an SNPN and the selected SNPN may be registered. The UE has the feature of supporting an equivalent SNPN list. The equivalent SNPN list may represent an SNPN list that the UE may consider as the same SNPN as the registered SNPN for cell selection, cell reselection, and handover according to information provided from the non-access stratum (NAS) (Equivalent SNPN list is a list of SNPNs considered as equivalent by the UE for cell selection, cell reselection, and handover according to the information provided by NAS).

FIG. 1H illustrates a procedure for a UE in an RRC inactive state (RRC_INACTIVE) to access a stand-alone non-public network (SNPN) cell and to resume an RRC connection in a next-generation mobile communication system according to an embodiment of the disclosure.

With reference to FIG. 1H, in operation 1h-03, a UE 1h-01 may configure an RRC connection with a base station 1h-02 and may be in an RRC connected mode (RRC_CONNECTED) (1h-05). The UE is a terminal that operates in a stand-alone none-public network (SNPN) access mode and also supports an equivalent SNPN list.

In operation 1h-10, the UE 1h-01 may transmit a UE capability information message (UECapabilityInformation) upon request from the base station 1h-02. The message may include information regarding whether the UE supports an equivalent SNPN list or whether the UE supports new RAN notification area information or newly added RAN notification area information in consideration of the equivalent SNPN list.

In operation 1h-15, the base station 1h-02 may transmit, to the UE 1h-01, an RRC connection release message (RRCRelease) that contains suspend configuration information (suspendConfig). RAN notification area information (RAN-NotificationAreaInfo) may be configured in the suspend configuration information through a RAN notification area information field (ran-NotificationAreaInfo), and one of fields, a cell list (cellList) and a RAN area configuration list (ran-AreaConfigList), may be configured in the RAN notification area information.
cellList: A PLMN-RAN-AreaCellList information element may be included, and this may be constituted with one or a plurality of PLMN-RAN-AreaCell information elements.
   Each PLMN-RAN-AreaCell information element may be constituted with a plmn-Identity field and a ran-AreaCells field. The plmn-Identity field may optionally include a PLMN identity (PLMN-Identity). The ran-AreaCells field may include one or a plurality of cell identities (CellIdentity). The base station may not include the plmn-Identity field for a UE that operates in an SNPN access mode and supports the equivalent SNPN list. Here, the base station may configure one or a plurality of cell identities included in the ran-AreaCells field to belong to a registered SNPN at all times. If the base station includes the plmn-Identity field for the UE that operates in the SNPN access mode and supports the equivalent SNPN list, the base station may configure the ran-AreaCells field associated with the PLMN identity to belong to the equivalent SNPN list at all times.
ran-AreaConfigList: A PLMN-RAN-AreaConfigList information element may be included, and this may be constituted with one or a plurality of PLMN-RAN-AreaConfig information elements.
   Each PLMN-RAN-AreaConfig information element may be constituted with a single plmn-Identity field and ran-Area field. The plmn-Identity field may optionally include a PLMN identity (PLMN-Identity). The ran-Area field may include one or a plurality of RAN-AreaConfig information elements. Each RAN-AreaConfig information element may be constituted with a tracking area code (TrackingAreaCode) and one or a plurality of RAN area codes (RAN-AreaCode). For reference, one or a plurality of RAN area codes may be optionally included. The base station may not include the plmn-Identity field for the UE that operates in the SNPN access mode and supports the equivalent SNPN list. Here, the base station may configure one or a plurality of RAN-AreaConfig information elements included in the ran-Area field to belong to the registered SNPN at all times. If the base station includes the plmn-Identity field for the UE that operates in the SNPN access mode and supports the equivalent SNPN list, the base station may configure the ran-Area field associated with the PLMN identity to belong to the equivalent SNPN list at all times.

In operation 1h-20, the UE 1h-01 may apply the received RRC connection release message and may shift to an RRC inactive state (RRC_INACTIVE).

In operation 1h-25, the UE 1h-01 may transmit an RRC connection resume request message (RRCResumeRequest or RRCResumeRequest1) to resume the RRC connection with the base station 1h-02.

In operation 1h-30, the base station 1h-02 that successfully receives the RRC connection resume request message may transmit an RRC connection resume message (RRCResume) to the UE 1h-01. In the case of successfully receiving the RRC connection resume message, the UE 1h-01 may apply configuration information included in the message and may switch to an RRC connected mode in operation 1h-31 and may consider a current cell as a primary cell (PCell).

In operation 1h-35, the UE 1h-01 that switches to the RRC connected mode may transmit an RRC connection resume complete message (RRCResumeComplete) to the base station 1h-02. If an upper layer device of the UE provides an SNPN, the UE may include selectedPLMN-Identity in the message as in the above-described embodiment 1e-.

A UE that operates in an SNPN access mode according to an embodiment of the disclosure has the feature of supporting an equivalent SNPN list. Therefore, when configuring RAN notification area information to the UE, the base station has the feature of configuring RAN notification area information to the UE such that ran-Area or ran-AreaCells may belong to a registered SNPN or the equivalent SNPN list at all times for each plmn-Identity field regardless of whether to configure RAN notification area information to a cell list field or a RAN area configuration list field. That is, the base station has the advantage of reducing signaling for configuring RAN notification area information by not including a separate NID in the RAN notification area information.

FIG. 1I illustrates a procedure for a UE in an RRC inactive state (RRC_INACTIVE) to access a stand-alone non-public network (SNPN) cell and to resume an RRC connection in a next-generation mobile communication system according to an embodiment of the disclosure.

With reference to FIG. 1I, in operation 1i-05, a UE 1i-01 may configure an RRC connection with a base station 1i-02 and may be in an RRC connected mode (RRC_CONNECTED) (1i-05). The UE 1i-01 may be a terminal that operates in a SNPN access mode and also supports an equivalent SNPN list according to the above-described embodiment.

In operation 1i-10, the UE 1i-01 may transmit a UE capability information message (UECapabilityInformation) upon request from the base station 1i-02. The message may include information regarding whether the UE 1i-01 supports the equivalent SNPN list or whether the UE 1i-02 supports new RAN notification area information or newly added RAN notification area information in consideration of the equivalent SNPN list.

In operation 1i-15, the base station 1i-02 may transmit, to the UE 1i-01, an RRC connection release message (RRCRelease) that contains suspend configuration information (suspendConfig). The disclosure has the feature defining a new RAN notification area information field (ran-NotificationAreaInfoSNPN) within the suspend configuration information and, through this, configuring a RAN notification area to the UE. That is, the base station 1i-01 has the feature of configuring the RAN notification area to the UE that operates in the SNPN access mode by not including a RAN notification area information field (ran-NotificationAreaInfo) of the above described embodiment 1f and by including a new RAN notification area information field in the suspend configuration information. One of fields, an SPN cell list (cellListSNPN) and an SNPN RAN area configuration list (ran-AreaConfigListSNPN), may be configured in the new RAN notification area information.
cellListSNPN: A PLMN-RAN-AreaCellSNPNList information element may be included, and this may be constituted with one or a plurality of PLMN-RAN-AreaCellSNPN information elements.
   Each PLMN-RAN-AreaCellSNPN information element may be constituted with a plmn-Identity field, an nid-List field, and a ran-AreaCells field. The plmn-Identity field may optionally include a PLMN identity (PLMN-Identity). The nid-List field may optionally include one or a plurality of NIDs. The ran-AreaCells field may include one or a plurality of cell identities (CellIdentity). If the plmn-Identity field and the nid-List field are not included, the base station may configure one or a plurality of cell identities included in the ran-AreaCells field to belong to a registered SNPN at all times. For reference, the plmn-Identity field and the nid-List field may be expressed as a single snpn field. The snpn field may include a single plmn-Identity field and nid-List field.
ran-AreaConfigSNPNList: A PLMN-RAN-AreaConfigSNPNList information element is included, and this is constituted with one or a plurality of PLMN-RAN-AreaConfigSNPN information elements.
   Each PLMN-RAN-AreaConfigSNPN information element may be constituted with a plmn-Identity field, an nid-List field, and a ran-Area field. The plmn-Identity field may optionally include a PLMN identity (PLMN-Identity). The nid-List field may optionally include one or a plurality of NIDs. The ran-Area field may include one or a plurality of RAN-AreaConfig information elements. Each RAN-AreaConfig information element may be constituted with a tracking area code (TrackingAreaCode) and one or a plurality of RAN area codes (RAN-AreaCode). For reference, one or a plurality of RAN area codes may be optionally included. If the plmn-Identity field and the nid-List field are not included, the base station may configure one or a plurality of RAN-AreaConfig information elements included in the ran-Area field to belong to the registered SNPN at all times. For reference, the plmn-Identity field and the nid-List field may be expressed as a single snpn field. The snpn field may include a single plmn-Identity field and nid-List field. For reference, when configuring the RAN notification area information, one or a plurality of NIDs may be separately defined in consideration for all PLMNs and an NID index for each PLMN may be configured. Alternatively, a plurality of NID lists may be defined and an index may be configured to determine which NID list is to use for each PLMN.

For example, the description may have ASN.1 structure as follows.

```
SuspendConfig ::= SEQUENCE {
  fullI-RNTI I-RNTI-Value,
  shortI-RNTI ShortI-RNTI-Value,
  ran-PagingCycle PagingCycle,
  ran-NotificationAreaInfo RAN-NotificationAreaInfo OPTIONAL,  -- Need M
  . . .
    ran-NotificationAreaInfoSNPN-r1RAN-NotificationAreaInfoSNPN-r18 OPTIONAL, -- Need S
```

| | |
|---|---|
| RAN-NotificationAreaInfoSNPN-r18 ::- | CHOICE : |

| | |
|---|---|
| cellListSNPN-r18 | PLMN-RAN-AreaCellListSNPN-r18 |

| | |
|---|---|
| ran-AreaConfigListSNPN-r18 | PLMN-RAN-AreaConfigListSNPN-r18, |
| . . . | |
| } | |
| PLMN-RAN-AreaCellListSNPN-r18 ::= | SEQUENCE (SIZE ( 1 . . . maxPLMNIdentities)) OF PLMN-RAN-AreaCellSNPN-r18 |
| PLMN-RAN-AreaCellSNPN-r18 ::= | SEQUENCE { |

| | |
|---|---|
| plmn-Identity | PLMN-Identity OPTIONAL, -- Need S |

| | |
|---|---|
| nid-List-r16 | SEQUENCE (SIZE (1 . . . maxNPN-r16) OF NID-r16 |

| | |
|---|---|
| ran-AreaCells | SEQUENCE (SIZE (1 . . . 32)) OF CellIdentity |

| | |
|---|---|
| } | |
| PLMN-RAN-AreaCellListSNPN-r18 ::= | SEQUENCE (SIZE ( 1 . maxPLMNIdentities)) OF PLMN-RAN-AreaCellSNPN-r18 |
| PLMN-RAN-AreaCellSNPN-r18 ::= | SEQUENCE { |

| | |
|---|---|
| plmn-Identity | PLMN-Identity OPTIONAL, -- Need S |

| | |
|---|---|
| nid-List-r16 | SEQUENCE (SIZE (1 . . . maxNPN-r16) OF NID-r16 |

| | |
|---|---|
| ran-Area | SEQUENCE (SIZE (1 . . . 16)) OF RAN-AreaConfig |

}

| | |
|---|---|
| RAN-AreaConfig ::= | SEQUENCE { |
| trackingAreaCode | TrackingAreaCode, |
| ran-AreaCodeList | . . . |

}

A new timer field may be defined in the suspend configuration information, and the field may include a timer value for periodic RAN notification area update (PeriodicRNAU-TimerValue). That is, the UE may drive the same if a new timer value is included, and may resume an RRC connection resume procedure for RAN notification area update if the timer expires.

In operation 1i-20, the UE 1i-01 may apply the received RRC connection release message and may shift to an RRC inactive state (RRC_INACTIVE).

In operation 1i-25, the UE 1i-01 may transmit an RRC connection resume request message (RRCResumeRequest or RRCResumeRequest1) to resume the RRC connection with the base station 1i-02.

In operation 1i-30, the base station 1i-02 that successfully receives the RRC connection resume request message may transmit an RRC connection resume message (RRCResume) to the UE 1i-01. In the case of successfully receiving the RRC connection resume message, the UE 1i-01 may apply configuration information included in the message and may switch to an RRC connected mode in operation 1i-31 (1i-31), and may consider a current cell as a primary cell (PCell).

In operation 1i-35, the UE 1i-01 that switches to the RRC connected mode may transmit an RRC connection resume complete message (RRCResumeComplete) to the base station 1i-02. If an upper layer device of the UE provides an SNPN, the UE may include selectedPLMN-Identity in the message as in the above-described embodiment 1e.

A UE that operates in an SNPN access mode according to an embodiment of the disclosure has the feature of supporting an equivalent SNPN list. Therefore, when configuring suspend configuration information within an RRC connection release message to the UE, the base station has the feature of configuring a RAN notification area to the UE that operates in the SNPN access mode by not including the RAN notification area information field (ran-NotificationAreaInfo) of the above-described embodiment 1f and by including new RAN notification area information (RAN-NotificationAreaInfoSNPN).

FIG. 1J illustrates a procedure for a UE in an RRC inactive state (RRC_INACTIVE) to access an SNPN cell and to resume an RRC connection in a next-generation mobile communication system according to an embodiment of the disclosure.

With reference to FIG. 1J, in operation 1j-03, a UE 1j-01 may configure an RRC connection with a base station 1j-02 and may be in an RRC connected mode (RRC_CONNECTED) (1j-05). The UE 1j-01 may be a terminal that operates in an SNPN mode and also supports an equivalent SNPN list according to the above-described embodiment.

In operation 1j-10, the UE 1j-01 may transmit a UE capability information message (UECapabilityInformation) upon request from the base station 1j-02. The message may include information regarding whether the UE supports the equivalent SNPN list or whether the UE supports new RAN notification area information or newly added RAN notification area information in consideration of the equivalent SNPN list.

In operation 1j-15, the base station 1j-02 may transmit, to the UE 1j-01, an RRC connection release message (RRCRelease) that contains suspend configuration information (suspendConfig). Herein, the suspend configuration information includes the RAN notification area information field (ran-NotificationAreaInfo) of the above-described embodiment 1f. Based on this, there is the feature of configuring RAN notification area information to the UE that operates in the SNPN access mode, including a new RAN notification area information field (ran-NotificationAreaInfo-v18xy) that may include additional information in the suspend configuration information. Specifically, an entry having the same order and the same number as the RAN notification area information field of the above-described embodiment 1f may be included in ran-NotificationAreaInfo-v18xy, and an nid-List field that may include one or a plurality of NIDs may be included for each entry of ran-NotificationAreaInfo-v18xy.

For example, if PLMN-RAN-AreaCellList is included in the RAN notification area information field of the above-described embodiment 1f, one or a plurality of NIDs for each PLMN-RAN-AreaCell may be included in ran-NotificationAreaInfo-v18xy. If a plmn-Identity field is not included in ran-NotificationAreaInfo and the nid-List field associated with corresponding plmn-Identity is not included in ran-NotificationAreaInfo-v18xy, the base station may configure one or a plurality of RAN-AreaConfig information elements included in the ran-Area field or one or a plurality of cell identities (CellIdentity) included in the ran-AreaCells field to belong to a registered SNPN at all times. Alternatively, ran-NotificationAreaInfo-v18xy may be associated with entries starting from a second entry of the RAN notification area information field of the above-described embodiment 1f. For example, a first entry included in ran-NotificationAreaInfo-v18xy may store a second ran-Area field included in ran-NotificationAreaInfo or one or a plurality of NID information mapped to a second ran-AreaCells field. This is because, in the above-described embodiment 1f, plmn-Identity is not included at all times, so nid-List may be signaled only when plmn-Identity is included. Alternatively, one or a plurality of NIDs may be separately defined and one or a plurality of NID indices may be included in ran-NotificationAreaInfo-v18xy in a RAN notification area for each PLMN included in ran-NotificationAreaInfo. Alternatively, a plurality of NID lists may be defined and an index indicating which NID list is mapped to the RAN notification area for each PLMN included in ran-NotificationAreaInfo may be included in ran-NotificationAreaInfo-v 18xy.

For example, the description may have ASN.1 structure as follows.

| | | |
|---|---|---|
| SuspendConfig ::= | SEQUENCE { | |
| fullI-RNTI | I-RNTI-Value, | |
| shortI-RNTI | ShortI-RNTI-Value, | |
| ran-PagingCycle | PagingCycle, | |
| ran-Notification AreaInfo | RAN-NotificationAreaInfo | OPTIONAL, -- Need M |
| . . . | | |

| | |
|---|---|
| ran-NotificationAreaInfo-v18xy | RAN-Notification AreaInfo-v18xy OPTIONAL, -- Need S |

| | |
|---|---|
| RAN-NotificationAreaInfo-v18xy ::= | CHOICE { |

| | |
|---|---|
| cellList-v18xy | PL.MN-RAN-AreaCellList-v 1 8xv. |
| ran-AreaConfigList-v18xy | PLMN-RAN-AreaConfigList-v18xy, |
| . . . | |

| PLMN-RAN-AreaCellList-v18xy ::= | SEQUENCE (SIZE (1 . . . maxPLMNIdentities) OF PLMN-RAN-AreaCell-v18xy | |
|---|---|---|
| PLMN-RAN-AreaCell-v18xy ::= | | SEQUENCE { |

| nid-List-r16 | SEQUENCE (SIZE (1 . . . maxNPN-r16) OF NID-r16 |
|---|---|
| PLMN-RAN-AreaConfigList-v1 8xy ::- | SEQUENCE (SIZE (1 . . . maxPLMNIdentities) OF PLMN-RAN-AreaConfig-v18xy |
| PI.MN-RAN-AreaConfig-v18xy ::- | SEQUENCE { |
| nid-List-r16 | |
| } | |

A new timer field may be defined in the suspend configuration information, and the field may include a timer value for periodic RAN notification area update (PeriodicRNAU-TimerValue). That is, the UE may drive the same if a new timer value is included, and may resume an RRC connection resume procedure for RAN notification area update if the timer expires.

In operation 1j-20, the UE 1j-01 may apply the received RRC connection release message and may shift to an RRC inactive state (RRC_INACTIVE).

In operation 1j-25, the UE 1j-01 may transmit an RRC connection resume request message (RRCResumeRequest or RRCResumeRequest1) to resume the RRC connection with the base station 1j-02.

In operation 1j-30, the base station 1j-02 that successfully receives the RRC connection resume request message may transmit an RRC connection resume message (RRCResume) to the UE 1j-01. In the case of successfully receiving the RRC connection resume message, the UE 1j-01 may apply configuration information included in the message and may switch to an RRC connected mode in operation 1j-31 (1j-31), and may consider a current cell as a primary cell (PCell).

In operation 1j-35, the UE 1j-01 that switches to the RRC connected mode may transmit an RRC connection resume complete message (RRCResumeComplete) to the base station 1j-02. If an upper layer device of the UE provides an SNPN, the UE may include selectedPLMN-Identity in the message as in the above-described embodiment 1e.

A UE that operates in an SNPN access mode according to an embodiment of the disclosure has the feature of supporting an equivalent SNPN list. Therefore, when configuring suspend configuration information within an RRC connection release message to the UE, the base station has the feature of configuring RAN notification area information in which the equivalent SNPN list is also considered to the UE that operates in the SNPN access mode by including the RAN notification area information field (ran-NotificationAreaInfo) of the above-described embodiment 1f and by additionally including one or a plurality of NIDs in RAN notification area information for each PLMN configured in ran-NotificationAreaInfo. Since the base station needs to includes information added to the previously defined RAN notification area information field in the suspend configuration information, there is the advantage of reducing singling and efficiently configuring a RAN notification area to the UE.

FIG. 1K is a block diagram illustrating an internal structure of a UE according to an embodiment of the disclosure.

With reference to the drawing, the UE includes a radio frequency (RF) processing unit 1k-10, a baseband processing unit 1k-20, a storage 1k-30, and a controller 1k-40.

The RF processing unit 1k-10 performs a function of transmitting and receiving signals through a wireless channel, such as signal band conversion and amplification. That is, the RF processing unit 1k-10 up-converts a baseband signal provided from the baseband processing unit 1k-20 to an RF band signal and transmits the same through an antenna, and down-converts an RF band signal received through the antenna to a baseband signal. For example, the RF processing unit 1k-10 may include a transmit filter, a receive filter, an amplifier, a mixer, an oscillator, a digital-to-analog convertor (DAC), and an analog-to-digital convertor (ADC). In the drawing, although only a single antenna is illustrated, the UE may include a plurality of antennas. Also, the RF processing unit 1k-10 may include a plurality of RF chains. Further, the RF processing unit 1k-10 may perform beamforming. For the beamforming, the RF processing unit 1k-10 may adjust the phase and magnitude of each of signals transmitted and received through a plurality of antennas or antenna elements. Also, the RF processing unit may perform multiple input multiple output (MIMO) and may receive a plurality of layers when performing a MIMO operation.

The baseband processing unit 1k-20 performs a conversion function between a baseband signal and a bitstream according to physical layer specifications of a system. For example, when transmitting data, the baseband processing unit 1k-20 generates complex symbols by encoding and modulating a transmission bitstream. Also, when receiving data, the baseband processing unit 1k-20 restores a received bitstream by demodulating and decoding a baseband 7 signal provided from the RF processing unit 1k-10. For example, in the case of following an orthogonal frequency division multiplexing (OFDM) scheme, when transmitting data, the baseband processing unit 1k-20 generates complex symbols by encoding and modulating the transmission bitstream, maps the complex symbols to subcarriers, and then generates OFDM symbols through inverse fast Fourier transform (IFFT) operation and cyclic prefix (CP) insertion. Also, when receiving data, the baseband processing unit 1k-20 divides the baseband signal provided from the RF processing unit 1k-10 based on units of OFDM symbols, restores signals mapped to subcarriers through fast Fourier transform (FFT), and then restores the received bitstream through demodulation and decoding.

The baseband processing unit 1k-20 and the RF processing unit 1k-10 transmit and receive signals as described above. Therefore, the baseband processing unit 1k-20 and the RF processing unit 1k-10 may be referred to as a transmitter, a receiver, a transceiver, or a communication unit. Further, at least one of the baseband processing unit 1k-20 and the RF processing unit 1k-10 may include a plurality of communication modules to support a plurality of different radio access technologies. Also, at least one of the baseband processing unit 1k-20 and the RF processing unit 1k-10 may include different communication modules to process signals of different frequency bands. For example, the different radio access technologies may include a wireless LAN (e.g., IEEE 802.11) and a cellular network (e.g., LTE). Also, the different frequency bands may include a super high frequency (SHF) (e.g., 2.NRHz, NRhz) band and a millimeter (mm) wave (e.g., 60 GHz) band.

The storage 1k-30 stores data, such as a basic program, an application program, and configuration information for operation of the UE. In particular, the storage 1k-30 may store information related to a second access node that performs wireless communication using a second radio access technology. The storage 1k-30 provides stored data upon request from the controller 1k-40.

The controller 1k-40 controls the overall operations of the UE. For example, the controller 1k-40 transmits and receives signals through the baseband processing unit 1k-20 and the RF processing unit 1k-10. Also, the controller 1k-40 writes and reads data to and from the storage 1k-40. To this end, the controller 1k-40 may include at least one processor. For example, the controller 1k-40 may include a communication processor (CP) that performs control for communication and an application processor (AP) that controls an upper layer, such as an application program.

FIG. 1L is a block diagram illustrating a configuration of a new radio (NR) base station according to an embodiment of the disclosure.

As shown in the drawing, the base station includes an RF processing unit 1l-10, a baseband processing unit 1l-20, a backhaul communication unit 1l-30, a storage 1l-40, and a controller 1l-50.

The RF processing unit 1l-10 performs a function of transmitting and receiving signals through a wireless channel, such as signal band conversion and amplification. That is, the RF processing unit 1l-10 up-converts a baseband signal provided from the baseband processing unit 1l-20 to an RF band signal and transmits the same through an antenna, and down-converts an RF band signal received through the antenna to a baseband signal. For example, the RF processing unit 1l-10 may include a transmit filter, a receive filter, an amplifier, a mixer, an oscillator, a DAC, and an ADC. In the drawing, although a single antenna is illustrated, the first access node may include a plurality of antennas. Also, the RF processing unit 1l-10 may include a plurality of RF chains. Further, the RF processing unit 1l-10 may perform beamforming. For the beamforming, the RF processing unit 1l-10 may adjust the phase and magnitude of each of signals transmitted and received through a plurality of antennas or antenna elements. The RF processing unit may perform MIMO operation by transmitting at least one layer.

The baseband processing unit 1l-20 performs a conversion function between a baseband signal and a bitstream according to physical layer specifications of a first radio access technology. For example, when transmitting data, the baseband processing unit 1l-20 generates complex symbols by encoding and modulating a transmission bitstream. Also, when receiving data, the baseband processing unit 1l-20 restores a received bitstream by demodulating and decoding a baseband signal provided from the RF processing unit 1l-10. For example, in the case of following an OFDM scheme, when transmitting data, the baseband processing unit 1l-20 generates complex symbols by encoding and modulating the transmission bitstream, maps the complex symbols to subcarriers, and then generates OFDM symbols through IFFT operation and CP insertion. Also, when receiving data, the baseband processing unit 1l-20 divides the baseband signal provided from the RF processing unit 1l-10 based on units of OFDM symbols, restores signals mapped to subcarriers through FFT operation, and then restores the received bitstream through demodulation and decoding. The baseband processing unit 1l-20 and the RF processing unit 1l-10 transmit and receive signals as described above. Therefore, the baseband processing unit 1l-20 and the RF processing unit 1l-10 may be referred to as a transmitter, a receiver, a transceiver, or a communication unit.

The backhaul communication unit 1l-30 provides an interface for performing communication with other nodes within a network. That is, the backhaul communication unit 1l-30 converts, to a physical signal, a bitstream transmitted from the main base station to another node, for example, an auxiliary base station and a core network, and converts a physical signal received from the other node to a bitstream.

The storage 1l-40 stores data, such as a basic program, an application program, and configuration information for operation of the main base station. In particular, the storage 1l-40 may store information on a bearer assigned to a connected UE and measurement results reported from the connected UE. Also, the storage 1l-40 may store information that serves as criteria to determine whether to provide multi-connection to the UE or suspend the same. The storage 1l-40 provides the stored data upon request from the controller 1l-50.

The controller 1l-50 controls the overall operations of the main base station. For example, the controller 1l-50 transmits and receives signals through the baseband processing unit 1l-20 and the RF processing unit 1l-10 or through the backhaul communication unit 1l-30. Also, the controller 1l-50 writes and reads data to and from the storage 1l-40. To this end, the controller 1l-50 may include at least one processor.

When the methods are implemented by software, a computer-readable storage medium for storing one or more programs (software modules) may be provided. The one or more programs stored in the computer-readable storage medium may be configured for execution by one or more processors within an electronic device. The at least one program may include instructions that cause the electronic device to perform the methods according to embodiments as defined by the claims or specification of the disclosure.

The programs (software modules or software) may be stored in non-volatile memories including a random access memory (RAM) and a flash memory, a read only memory (ROM), an electrically erasable programmable read only memory (EEPROM), a magnetic disc storage device, a compact disc-ROM (CD-ROM), digital versatile discs (DVDs), other type optical storage devices, or a magnetic cassette. Alternatively, the programs may be stored in a memory configured with any combination of some or all of the memory devices. Also, a plurality of such configuration memories may be included.

Also, the programs may be stored in an attachable storage device accessible through communication networks, such as the Internet, Intranet, a local area network (LAN), a wide LAN (WLAN), and a storage area network (SAN) or a combination thereof. Such a storage device may access a device performing the embodiments of the disclosure via an external port. Also, a separate storage device on the communication network may access the device performing the embodiments of the disclosure.

In the above-described detailed embodiments of the disclosure, a component included in the disclosure is expressed in the singular form or the plural form according to presented detailed embodiments. However, the singular form or the plural form is selected appropriately to the presented situation for convenience of description, and the disclosure is not limited by components expressed in the singular form or the plural form. Therefore, a component expressed in the plural form may also include a single component or a component expressed in the singular form may also include a plurality of components.

Meanwhile, although the detailed description of the disclosure describes specific embodiments, it is apparent that various modifications may be made without departing from the scope of the disclosure. Therefore, the scope of the disclosure should not be limited to the described embodiments and should be determined not only by the scope of the claims described below but also by the equivalents thereof.

The embodiments of the present invention disclosed in the present specification and drawings merely present specific examples to easily explain the technical contents of the present invention and to help understanding of the present invention and are not construed to limit the scope of the present invention. It will be apparent to one of ordinary skill in the art to which the present invention pertains that other modified examples based on the technical spirit of the present invention may be implemented in addition to the embodiments disclosed herein.

1. A method performed by a user equipment (UE) in a wireless communication system, the method comprising:
receiving, from a base station, a radio resource control (RRC) release message that includes public land mobile network (PLMN) identity information (PLMN identifier (ID)) and at least one network identifier (NID) information related to the PLMN ID;
transitioning to RRC inactive based on the RRC release message; and
identifying whether a standalone non-public network (SNPN) is an equivalent SNPN capable of being considered equivalent to a registered SNPN, based on the PLMN ID and the at least one NID information related to the PLMN ID.

2. The method of claim 1,
wherein the PLMN ID and the at least one NID are included in SNPN-related RAN notification area information (RAN-NotificationAreaInfoSNPN), and
wherein the RRC release message does not include RAN notification area information (RAN-NotificationAreaInfo).

3. The method of claim 1,
wherein the PLMN ID is included in RAN notification area information (RAN-NotificationAreaInfo), and
wherein the at least one NID is included in second information (RAN-NotificationAreaInfo-v18xy) related to an entry of the RAN notification area information (RAN-NotificationAreaInfo).

4. The method of claim 1, further comprising:
transmitting, to the base station, a UE capability information message that includes an indicator related to an equivalent SNPN support status of the UE.

5. The method of claim 1, further comprising:
transmitting, to the base station, an RRC connection resume request message;
receiving, from the base station, an RRC resume message; and
transmitting, to the base station, an RRC connection resume complete message that includes selected PLMN identity information (selectedPLMN-Identity).

6. A method performed by a base station in a wireless communication system, the method comprising:
receiving, from a user equipment (UE), a UE capability information message that includes an indicator related to a support status of an equivalent standalone non-public network (equivalent SNPN) capable of being considered equivalent to a registered SNPN;
generating a radio resource control (RRC) release message that includes public land mobile network (PLMN) identity information (PLMN identifier (ID)) and at least one network identifier (NID) information related to the PLMN ID, to the UE, based on the UE capability information message; and
transmitting an RRC release message that includes the PLMN ID and the at least one NID information related to the PLMN ID.

7. The method of claim 6,
wherein the PLMN ID and the at least one NID are included in SNPN-related RAN notification area information (RAN-NotificationAreaInfoSNPN), and
wherein the RRC release message does not include RAN notification area information (RAN-NotificationAreaInfo).

8. The method of claim 6,
wherein the PLMN ID is included in RAN notification area information (RAN-NotificationAreaInfo), and
wherein the at least one NID is included in second information (RAN-NotificationAreaInfo-v18xy) related to an entry of the RAN notification area information (RAN-NotificationAreaInfo).

9. The method of claim 6, further comprising:
receiving, from the UE, an RRC connection resume request message;
transmitting, to the UE, an RRC resume message; and
receiving, from the UE, an RRC connection resume complete message that includes selected PLMN identity information (selectedPLMN-Identity).

10. A user equipment (UE) in a wireless communication system, the UE comprising:
a transceiver configured to transmit and receive a signal; and
a controller,
wherein the controller is configured to;
receive, from a base station, a radio resource control (RRC) release message that includes public land mobile network (PLMN) identity information (PLMN identifier (ID)) and at least one network identifier (NID) information related to the PLMN ID,
transition to RRC inactive based on the RRC release message, and
identify whether a standalone non-public network (SNPN) is an equivalent SNPN capable of being considered equivalent to a registered SNPN based on the PLMN ID and the at least one NID information related to the PLMN ID.

11. The UE of claim 10,
wherein, when the PLMN ID and the at least one NID are included in SNPN-related RAN notification area information (RAN-NotificationAreaInfoSNPN), the RRC release message does not include RAN notification area information (RAN-NotificationAreaInfo), and
wherein, when the PLMN ID is included in RAN notification area information (RAN-NotificationAreaInfo), the at least one NID is included in second information (RAN-NotificationAreaInfo-v18xy) related to an entry of the RAN notification area information (RAN-NotificationAreaInfo).

12. The UE of claim 10, wherein the controller is configured to:
transmit, to the base station, a UE capability information message that includes an indicator related to an equivalent SNPN support status of the UE;
transmit, to the base station, an RRC connection resume request message,
receive, from the base station an RRC resume message; and
transmit, to the base station, an RRC connection resume complete message that includes selected PLMN identity information (selectedPLMN-Identity).

13. A base station in a wireless communication system, the base station comprising:
a transceiver configured to transmit and receive a signal; and
a controller,
wherein the controller is configured to:
receive, from a user equipment (UE), a UE capability information message that includes an indicator related to a support status of an equivalent standalone non-public network (equivalent SNPN) capable of being considered equivalent to a registered SNPN,
generate a radio resource control (RRC) release message that includes public land mobile network (PLMN) identity information (PLMN identifier (ID)) and at least one network identifier (NID) information related to the PLMN ID, to the UE, based on the UE capability information message, and
transmit an RRC release message that includes the PLMN ID and the at least one NID information related to the PLMN ID.

14. The base station of claim 13,
wherein, when the PLMN ID and the at least one NID are included in SNPN-related RAN notification area information (RAN-NotificationAreaInfoSNPN), the RRC release message does not include RAN notification area information (RAN-NotificationAreaInfo), and
wherein, when the PLMN ID is included in RAN notification area information (RAN-NotificationAreaInfo), the at least one NID is included in second information (RAN-NotificationAreaInfo-v18xy) related to an entry of the RAN notification area information (RAN-NotificationAreaInfo).

15. The base station of claim 13, wherein the controller is configured to:
receive, from the UE, an RRC connection resume request message;
transmit, to the UE, an RRC resume message; and
receive, from the UE, an RRC connection resume complete message that includes selected PLMN identity information (selectedPLMN-Identity).
